(19) United States
(12) Patent Application Publication
(10) Pub. No.: US 2022/0377840 A1
(43) Pub. Date: Nov. 24, 2022

(54) IOPS IP CONNECTIVITY ANNOUNCEMENT METHOD

(71) Applicant: Telefonaktiebolaget LM Ericsson (publ), Stockholm (SE)

(72) Inventor: John Camilo Solano Arenas, Neuss (DE)

(21) Appl. No.: 17/771,153

(22) PCT Filed: Oct. 22, 2020
(86) PCT No.: PCT/EP2020/079804

§ 371 Date: Apr. 22, 2022

Related U.S. Application Data
(60) Provisional application No. 62/925,837, filed on Oct. 25, 2019.

(51) Int. Cl. H04W 76/45; H04W 76/50; H04W 4/90

(52) U.S. Cl. CPC H04W 76/45; H04W 76/50; H04W 4/90

(57) ABSTRACT

Disclosed herein is a method and a wireless communication device for performing the method. The method comprising: sending to an IOPS MC system associated with one or more radio access nodes of a cellular communications system, an IP connectivity announcement request or an IP connectivity group announcement request for announcing availability of the wireless device to one or more other devices served by the IOPS MC system; and receiving, from the IOPS MC system, an IP connectivity announcement response or an IP connectivity group announcement response.

### 1 BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Mission Critical (MC) communication services are essential for the work performed by public safety users, e.g., police and fire brigade. The MC communications service requires preferential handling compared to normal telecommunication services including handling of prioritized MC calls for emergency and imminent threats. Furthermore, the MC communications service requires several resilience features that provide a guaranteed service level even if part of the network or backhaul infrastructure fails.

The most commonly used communication method for public safety users is Group Communication (GC) which requires that the same information is delivered to multiple users. One type of Group Communication is Push to Talk (PTT) service. A Group Communication system can be designed with a centralized architecture approach, in which a centralized GC control node provides full control of all group data, e.g., group membership, policies, user authorities, and prioritizations. Such approach requires a network infrastructure that provides high network availability. This type of operation is sometimes known as Trunked Mode Operation (TMO) or on-network operation.

Third Generation Partnership Project (3GPP) based networks supporting GC services or MC services like Mission Critical Push To Talk (MCPTT) are specified in 3GPP TS 23.280 v16.3.0 and 3GPP TS 23.379 v16.3.0. Other MC services like Mission Critical Video (MCVideo) is specified in 3GPP TS 23.281 v16.3.0 and Mission Critical Data (MCData) is specified in 3GPP TS 23.282 v16.3.0.

Each MC service supports several types of communications amongst the users (e.g., group call, private call). There are several common functions and entities (e.g., group, configuration, identity) which are used by the MC services. The common functional architecture, described in 3GPP TS 23.280 v16.3.0, to support MC services comprises a central MC service server connected to the network providing full control of the MC service data and MC service client(s) operating on a User Equipment (UE) providing MC service communications support. The MC service UE primarily obtains access to a MC service via Evolved Universal Mobile Telecommunications System (UMTS) Terrestrial Radio Access Network (E-UTRAN), using the evolved packet system (EPS) architecture defined in 3GPP TS 23.401 v16.3.0.

If a MC service UE is going out of the network coverage, it can attempt to switch to the off-network mode of operation to make use of proximity services (ProSe) as specified in 3GPP TS 23.303 v15.1.0. ProSe provides support to the off-network operation based on a direct communication with another UE without direct support from the network. In this case, the MC service clients operating on the

UEs are controlling and providing the MC service communication. For that, all the configuration data (which is similar to but normally a subset of the configuration data for an on-network operation) must be pre-provisioned to each UE.

In a 3GPP based network that provides MC services, the service can be guaranteed even in the case of backhaul failure by using the feature known as Isolated E-UTRAN Operations for Public Safety (IOPS) described in 3GPP TS 23.401 v16.3.0 Annex K. The IOPS functionality provides local connectivity to the public safety users' devices that are within the communication range of E-UTRAN radio base station(s) (eNB(s)) that supports IOPS, i.e., one or more IOPS-capable eNBs. The IOPS-capable eNB(s) is co-sited with a local Evolved Packet Core (EPC) which is used during the IOPS mode of operation. The local EPC may include the following functional entities: Mobility Management Entity (MME), Serving Gateway (S-GW), Packet Data Network Gateway (P-GW), and Home Subscriber Server (HSS).

The IOPS EPS, i.e., the IOPS-capable eNB(s) and the local EPC, can be used in different types of deployments. One common scenario is when radio base station is located on a remote location (e.g., an island) and the radio base station is connected to the macro core network via e.g., a microwave link. If there is a microwave link failure, it is critical for Public Safety users to be able to at least have local connectivity for the communication between the users in the coverage of the IOPS-capable eNBs.

When the IOPS mode of operation is initiated, e.g., due to a backhaul link failure, the public safety/MC users should be able to begin being served by the IOPS EPS. During the IOPS mode of operation, the MC services can be supported based on an off-network like operation, where the IOPS MC system only provides Internet Protocol (IP) connectivity for the communication among the MC users. Thus, the MC services are directly provided by the MC users, but the corresponding MC service IP packets are transmitted over the IOPS EPS to an lops MC system. The IOPS MC system, which is co-located with the IOPS EPS, distributes those IP packets to the targeted user(s) over the IOPS EPS.

### FIG. 1

The IOPS MC system can be represented by a functional model which consists of two IOPS application functions (IOPS AFs): an IOPS packet distribution function and an IOPS connectivity function. On the other hand, the UE includes an MC service client and an IOPS connectivity client to support MC services in the IOPS mode of operation. A general IOPS system is depicted in FIG. 1.

The IOPS MC system, i.e., the IOPS connectivity function, enables MC users operating on the UEs to be registered and discovered in the IOPS mode of operation. The IOPS MC system, i.e., the IOPS distribution function, provides IP connectivity for the MC service communication among the MC users. This means that the IOPS MC system distributes IP packets received from an MC user targeting one or more MC users. For the case of IP packets related to group communications, e.g., IP packets targeting multiple users in a group call, the IOPS MC system can distribute them to the targeted users over unicast and/or multicast transmissions over the IOPS EPS network.

Considering that the IOPS mode of operation is an off-network like operation, for the case of a one to one communication, e.g., a private call between two users, the IP packets received by the IOPS distribution function have, as their final destination IP address, the unicast IP address of the targeted user. For the case of a group communication, e.g., a group call, the IP packets received by the IOPS distribution function have, as their final destination IP address, the multicast IP address of the targeted group.

Some methods have been proposed for supporting the discovery of users and the IP connectivity functionality in the IOPS mode of operation, respectively. For the discovery of users, these methods are based on the publication of user information to the IOPS MC system and the subscription and notification to receive connectivity information from other users on the system. These methods are also included in 3GPP TR 23.778 v16.0.0.

The support of MC services in the IOPS mode of operation is being specified in 3GPP TS 23.180 (currently in TS 23.180 v0.1.0).

### 2 SUMMARY

There currently exist certain challenge(s). The support of MC services in the IOPS mode of operation is being specified in Release 17 3GPP TS 23.180. For that, methods are required to define how MC users that have been discovered by the IOPS MC system can provide and obtain connectivity information to establish a communication over the IOPS MC system. Also, information flows and procedures for these methods need to be specified.

Certain aspects of the present disclosure and their embodiments may provide solutions to the aforementioned or other challenges. In some embodiments of the proposed solutions, methods for providing and obtaining connectivity information from MC users (i.e., wireless communication devices, such as UEs, have respective MC service clients) that have been discovered by the IOPS MC system in the IOPS mode of operation are disclosed. The connectivity information is used by MC users to establish an IP connectivity communication with other MC users over the IOPS MC system. Also, procedures are defined for the discovery, subscription, and notification methods.

There are, proposed herein, various embodiments which address one or more of the issues disclosed herein.

One embodiment is directed to a method performed by a wireless communication device, the method comprising: sending, to an isolated operation for public safety, IOPS, mission critical, MC, system associated with one or more radio access nodes of a cellular communications system, an Internet Protocol, IP, connectivity announcement request or an IP connectivity group announcement request for announcing availability of the wireless device to one or more other devices served by the IOPS MC system; and receiving, from the IOPS MC system, an IP connectivity announcement response or an IP connectivity group announcement response.

Another embodiment is directed to a method performed by an IOPS MC system associated with one or more radio access nodes of a cellular communications system, the method comprising: receiving, from a first wireless communication device, an IP connectivity announcement request or an IP connectivity group announcement request; and sending, to the first wireless communication device, an IP connectivity announcement response or an IP connectivity group announcement response.

Another embodiment is directed to a method performed by a wireless communication device, the method comprising: sending, to an IOPS MC system associated with one or more radio access nodes of a cellular communications system, an IOPS discovery request; and receiving, from the IOPS MC system, an IOPS discovery response.

Another method is directed to a method performed by an IOPS MC system associated with one or more radio access nodes of a cellular communications system, the method comprising: receiving, from a wireless communication device, an IOPS discovery request; and sending, to the wireless communication device, an IOPS discovery response.

Another embodiment is directed to a method performed by a wireless communication device, the method comprising: sending, to an IOPS MC system associated with one or more radio access nodes of a cellular communications system, an IP connectivity subscribe request; and receiving, from the IOPS MC system, an IP connectivity subscribe response.

Another embodiment is directed to a method performed by an IOPS MC system associated with one or more radio access nodes of a cellular communications system, the method comprising: receiving, from a wireless communication device, an IP connectivity subscribe request; and sending, to the wireless communication device, an IP connectivity subscribe response.

Another embodiment is directed to a method performed by a wireless communication device, the method comprising: receiving, from an IOPS MC system associated with one or more radio access nodes of a cellular communications system, an IP connectivity notify request or an IP connectivity group notify request; and sending, to the IOPS MC system, an IP connectivity notify response or an IP connectivity group notify response.

Another embodiment is directed to a method performed by an IOPS MC system associated with one or more radio access nodes of a cellular communications system, the method comprising: sending, to a wireless communication device, an IP connectivity notify request or an IP connectivity group notify request; and receiving, from the wireless communication device, an IP connectivity notify response or an IP connectivity group notify response.

Certain embodiments may provide one or more of the following technical advantage(s). At least some embodiments of the present disclosure provide one or more of the following advantages:
an MC user can announce its availability to establish an IP connectivity communication over the IOPS MC system to other MC users on the system.
discovery of MC users in the IOPS mode of operation as well as for subscription and notification of connectivity information is enabled.

### 3 BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 depicts a general Isolated Operation for Public Safety (IOPS) system;

FIG. 2 illustrates one example of a cellular communications system 200 in which embodiments of the present disclosure may be implemented;

FIG. 3 illustrates one example architecture for embodiments of the present disclosure;

FIG. 4 illustrates a procedure for IP connectivity announcement from MC users in a IOPS mode of operation according to an embodiment of the present disclosure;

FIG. 5 illustrates another procedure for IP connectivity announcement from MC users in a IOPS mode of operation according to an embodiment of the present disclosure;

FIG. 6 illustrates a procedure for the discovery of MC users in an IOPS mode of operation according to an embodiment of the present disclosure;

FIG. 7 illustrates a procedure for IP connectivity subscription of MC users in an IOPS mode of operation according to an embodiment of the present disclosure;

FIG. 8 illustrates a procedure for IP connectivity notification of MC users in an IOPS mode of operation according to an embodiment of the present disclosure;

FIG. 9 illustrates a procedure for IP connectivity group notification of MC users in an IOPS mode of operation according to an embodiment of the present disclosure;

FIG. 10 is a schematic block diagram of a radio access node 1000 according to some embodiments of the present disclosure;

FIG. 11 is a schematic block diagram that illustrates a virtualized embodiment of the radio access node 1000 according to some embodiments of the present disclosure;

FIG. 12 is a schematic block diagram of the radio access node 1000 according to some other embodiments of the present disclosure;

FIG. 13 is a schematic block diagram of a wireless communication device 1300 according to some embodiments of the present disclosure;

FIG. 14 is a schematic block diagram of the wireless communication device 1300 according to some other embodiments of the present disclosure.

### 4 DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in the document(s) provided in the Appendix.

Radio Node: As used herein, a “radio node” is either a radio access node or a wireless communication device.

Radio Access Node: As used herein, a “radio access node” or “radio network node” or “radio access network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Embodiments of the solutions described herein are described within the context of a 3GPP-based Long Term Evolution (LTE) network, i.e., an EPS including E-UTRAN and EPC. However, the problems and solutions described herein are equally applicable to wireless access networks and UE implementing other access technologies and standards (e.g., a Fifth Generation (5G) system including 5G core and 5G radio access). LTE is used as an example technology where the embodiments of the solutions described herein are suitable. Since the embodiments of the solutions described herein are suitable for LTE, using LTE in the description therefore is particularly useful for understanding the problems and solutions disclosed herein for solving those problems. Furthermore, embodiments of the solutions described herein focus on the IOPS mode of operation; however, the problems and solutions described herein are also equally applicable to other scenarios, e.g., for the case of implementing a private network, a.k.a. non-public networks (NPN), with a local EPC or 5GC to provide application services to authorized users within the private network coverage area.

In some embodiments of the proposed solutions, methods for providing and obtaining connectivity information from MC users (i.e., wireless communication devices, such as UEs, have respective MC service clients) that have been discovered by the IOPS MC system in the IOPS mode of operation are disclosed. The connectivity information is used by MC users to establish an IP connectivity communication with other MC users over the IOPS MC system. Also, procedures are defined for the discovery, subscription, and notification methods.

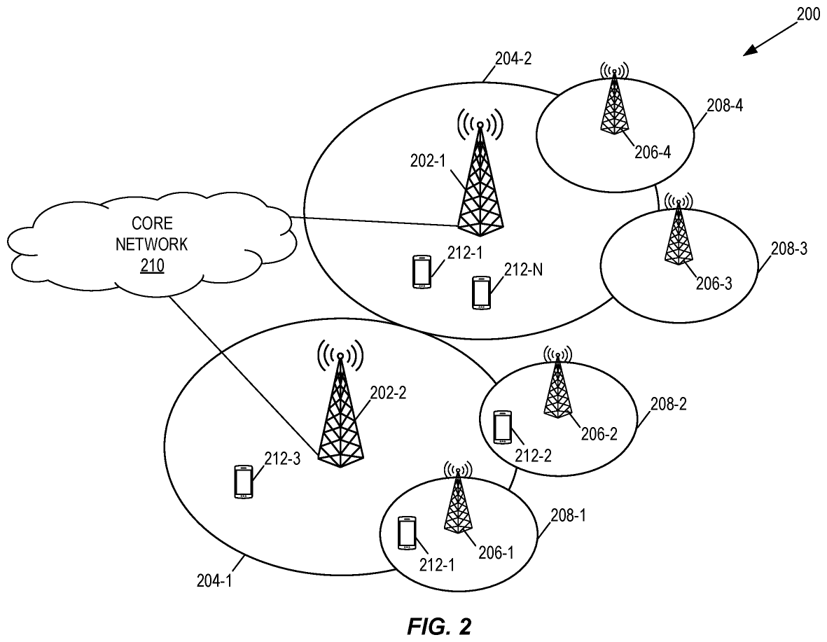

FIG. 2

In this regard, FIG. 2 illustrates one example of a cellular communications system 200 in which embodiments of the present disclosure may be implemented. In the embodiments described herein, the cellular communications system 200 is an Evolved Packet System (EPS) including a LTE RAN (i.e., an E-UTRAN); however, the embodiments described herein are equally applicable to other types of cellular communications systems such as, e.g., a 5G system. In this example, the RAN includes base stations 202-1 and 202-2, which in LTE are referred to as eNBs, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5GS is referred to as the 5G core (5GC). The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

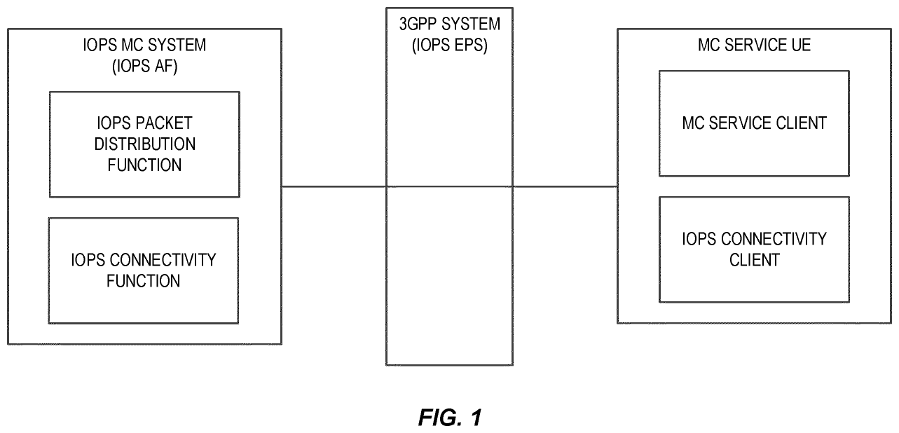

While not illustrated, at least some of the base stations 202 and/or low power nodes 206 include or are connected to a local core (e.g., a Local EPC for LTE) and an IOPS MC system. As illustrated in FIG. 1, the IOPS MC system includes an IOPS packet distribution function and an IOPS connectivity function. In the example embodiments described herein in which the cellular communications system 200 is an LTE system, the base stations 202 are eNBs, and one or more of these eNBs support IOPS (i.e., one or more of the eNBs are IOPS-capable eNBs). Further, using IOPS, the cellular communications system together with the IOPS MC system 200 support a MC service(s) (e.g., a MCPTT service) and enables the MC service(s) even in the case of backhaul failure by using the IOPS feature. Further, at least some of the wireless communication devices 212 are MC service devices (e.g., MC service UEs).

In this regard, the discussion now turns to some example embodiments implemented in an LTE system to provide MC service(s) (e.g., MC service(s) such as, e.g., MCPTT) using IOPS to guarantee the MC service(s) even when there is a failure in the backhaul network (i.e., the network connecting the eNB(s) to the EPC).

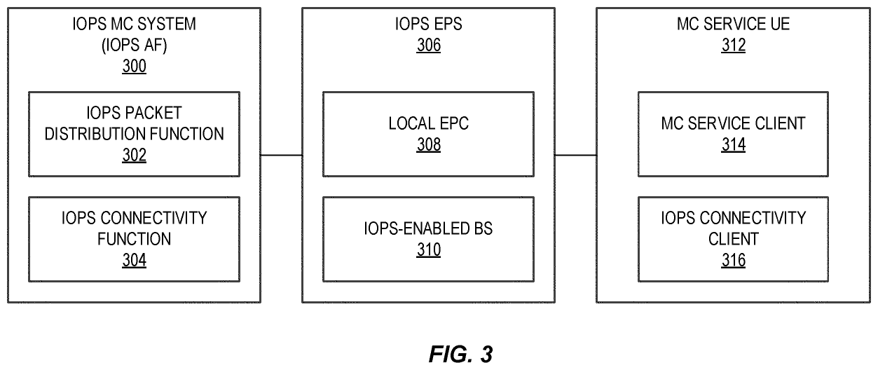

### FIG. 3

In this regard, FIG. 3 illustrates one example architecture for embodiments of the present disclosure. As illustrated, the architecture includes an IOPS MC system 300 that includes an IOPS packet distribution function 302 and an IOPS connectivity function 304, an IOPS EPS including a local EPC 308 and an IOPS-enabled base station 310, and a MC service UE 312 including an MC service client 314 and an IOPS connectivity client 318. While illustrated separately for clarity and ease of discussion, it should be noted that the local EPC 308 may be implemented either separate from or within the IOPS enabled base station 310. Likewise, the IOPS MC system may be implemented either separate from or within the IOPS enabled base station 310.

Also note that the IOPS enabled base station 310 may be, e.g., any of the base stations 202 of FIG. 2. Likewise, the MC service UE 312 may be, e.g., any one of the UEs 212 of FIG. 3.

Lastly, while only one MC service UE 312 is illustrated in FIG. 3, there can be many MC service UEs 312 using the IOPS MC system 300. To distinguish between such MC service UEs, the notation of MC service UE 312-X is used herein, where X may be, e.g., 1, 2, . . . , N. Likewise, while only one IOPS enabled base station 310 is illustrated in FIG. 3, there may be one or more IOPS enabled base stations 310 within the coverage area of the IOPS MC system (e.g., all base stations on an island).

Throughout the following description, it is assumed that the public safety users, also referred to herein as MC service UEs or MC users or just UEs or users, have been provided with the configuration needed to support MC services. Such a configuration, to be referred to herein as a “MC service user configuration profile”, is assumed to be stored at the UEs (e.g., stored by MC service clients operating on the UEs). For each UE, the MC service user configuration profile may comprise information (e.g., static data) needed for the configuration of the MC service (e.g., MCPTT service) that is supported by the UE in question. For each UE, the MC service user configuration profile may contain information about at least one of: the current UE configuration, MC service user profile configuration, group configuration (e.g., group ID), and service configuration data or similar which is stored at the UE for off-network operation (the specific parameters are described in 3GPP TS 23.280 Annex A and 3GPP TS 23.379 Annex A for the MC services and MCPTT service UE/off-network, respectively). The MC service user configuration profile can be provisioned by either offline procedures or after the UEs have been authenticated and registered with the central MC system.

The user configuration profile can also include specific configuration to be utilized in the IOPS mode of operation. It can include specific IOPS group configuration, e.g., IOPS group IP multicast addresses associated to IOPS MC service groups that a user can belong to.

In the case there is a link failure between the radio access network (eNBs) and the macro core network (EPC), it is assumed that the IOPS mode of operation is initiated, i.e., an off-network like operation, where the MC services are directly provided by the MC users, but the corresponding MC service IP packets are transmitted over the IOPS MC system. This means that the IOPS MC system only provides IP connectivity for the communication among the users. This is also defined as an IP connectivity communication in the IOPS mode of operation. For that, authorized UEs have been configured to support the IOPS mode of operation.

### 4.1 IP Connectivity Announcement

The support of the IP connectivity functionality in the IOPS mode of operation enables that MC services are provided by the MC service clients operating on the MC service UEs via the IOPS MC system.

In one embodiment of the present disclosure, an MC user that has been discovered by the IOPS MC system can request to the IOPS MC connectivity function to announce to other discovered MC users its connectivity information on the system. This announcement message can be transmitted to other MC users on the system, although, those MC users haven't subscribed to receive such information.

The following clauses specify the IOPS IP connectivity announcement procedures and information flows for the IP connectivity functionality in the IOPS mode of operation, in accordance with some example embodiments of the present disclosure.

### 4.1.1.1 IP Connectivity Announcement Request (from the IOPS Connectivity Client to the IOPS MC Connectivity Function)

Table 2.2.1.1-1 describes the information flow for the IP connectivity announcement request from the IOPS connectivity client at the MC UE to the IOPS MC connectivity function at the IOPS MC system, which may be implemented at a respective radio access node (e.g., eNB) or implemented at a node that is connected to the radio access node (e.g., eNB) (e.g., locally). This IP connectivity announcement request is used to announce a specific MC service ID(s) within the system.

TABLE 2.2.1.1-1
IP connectivity announcement request

| Information | | |
|---|---|---|
| element | Status | Description |
| MC user ID | M | The MC ID of the requesting MC user |
| List of MC | M | It provides the specific list of MC service IDs (e.g. |
| service IDs | | MCPTT ID, MCData ID) from the requesting MC |
| | | user to be announced as available to other MC |
| | | users on the system |
| List of MC | O | It provides a specific target list of MC service IDs |
| service IDs | | (e.g. MCPTT ID, MCData ID) to which to announce |
| (NOTE) | | the requesting MC user's connectivity information |

NOTE:
There is a match between the MC service IDs list from the requesting MC user and the targeted MC service IDs, i.e. a requesting MC service ID is requested to be announced to specific targeted MC service ID(s) from the same MC service.

Note that a particular MC user (or MC UE) has a MC identifier (ID). For each MC service of the MC user, the MC user has a separate MC service ID. For example, if a particular MC user has two MC services X and Y, then the MC user will have an MC ID that identifies the MC user, a first MC service ID (MC service ID X) that corresponds to MC service X and is associated with the MC ID of the MC user, and a second MC service ID (MC service ID Y) that corresponds to MC service Y and is associated with the MC ID of the MC user. An MC service ID is also referred to herein as an “MC service user ID”.

### 4.1.1.2 IP Connectivity Announcement Response (from the IOPS MC Connectivity Function to the IOPS Connectivity Client)

Table 2.2.1.2-1 describes the information flow for the IP connectivity announcement response from the IOPS MC connectivity function at the IOPS MC system to the IOPS connectivity client at the MC UE.

TABLE 2.2.1.2-1
IP connectivity announcement response

| Information | | |
|---|---|---|
| element | Status | Description |
| MC user ID | M | The MC ID of the requesting MC user |
| List of MC | M | It lists the MC service IDs from the requesting |
| service IDs | | MC user for which the announcement request |
| | | was accepted |
| List of MC | O | It lists the targeted MC service IDs for which the |
| service IDs | | corresponding requesting MC user's MC service |
| (NOTE) | | ID announcement request was accepted |

NOTE:
There is a match between the MC service IDs list from the requesting MC user and the targeted MC service IDs.

### 4.1.1.3 IP connectivity announcement request (from the IOPS MC connectivity function to the IOPS connectivity client)

Table 2.2.1.3-1 describes the information flow for the IP connectivity announcement request from the IOPS MC connectivity function at the IOPS MC system to the IOPS connectivity client at the MC UE. This IP connectivity announcement request is used to announce a specific MC service ID(s) within the system.

TABLE 2.2.1.3-1
IP connectivity announcement request

| Information element | Status | Description |
|---|---|---|
| MC user ID | M | The MC ID associated to the MC service ID |
| | | receiving the announcement request |
| MC service ID | M | The announcing MC service ID for which |
| | | connectivity information is being provided |
| Connectivity | M | It provides the connectivity information of the |
| information | | announcing MC service ID. It includes the MC |
| | | service UE’s IP address of the announcing MC |
| | | service ID in the system |

### 4.1.1.4 IP Connectivity Announcement Response (from the IOPS Connectivity Client to the IOPS MC Connectivity Function)

Table 2.2.1.4-1 describes the information flow for the IP connectivity announcement response from the IOPS connectivity client at the MC UE to the IOPS MC connectivity function at the IOPS MC system.

TABLE 2.2.1.4-1
IP connectivity announcement response

| Information element | Status | Description |
|---|---|---|
| MC user ID | M | The MC ID of the responding MC user |
| MC service ID | M | The MC service ID for which connectivity |
| | | information was received |

### 4.1.1.5 IP connectivity group announcement request (from the IOPS connectivity client to the IOPS MC connectivity function)

Table 2.2.1.5-1 describes the information flow for the IP connectivity group announcement request from the IOPS connectivity client at the MC UE to the IOPS MC connectivity function at the IOPS MC system. This IP connectivity group announcement request is used to announce the availability of MC users from specific IOPS MC service group IDs within the system. The availability only indicates the number of available discovered users from an IOPS MC group ID.

TABLE 2.2.1.5-1
IP connectivity group announcement request

| Information | | |
|---|---|---|
| element | Status | Description |
| MC user ID | M | The MC ID of the requesting MC user |
| List of IOPS | M | It provides a specific list of IOPS MC service group |
| groups (NOTE) | | IDs for which the requesting MC user intends to |
| | | announce its availability on the system |

NOTE:
The listed IOPS groups belong to the requesting MC user's IOPS groups list indicated in the IOPS discovery request.

### 4.1.1.6 IP connectivity group announcement response (from the IOPS MC connectivity function to the IOPS connectivity client)

Table 2.2.1.6-1 describes the information flow for the IP connectivity group announcement response from the IOPS MC connectivity function at the IOPS MC system to the IOPS connectivity client at the MC UE.

TABLE 2.2.1.6-1:
IP connectivity group announcement response

| Information | | |
|---|---|---|
| element | Status | Description |
| MC user ID | M | The MC ID of the requesting MC user |
| List of IOPS | M | It lists the IOPS MC service group IDs for which the |
| groups | | group announcement request was accepted |

### 4.1.1.7 IP connectivity group announcement request (from the IOPS MC connectivity function to the IOPS connectivity client)

Table 2.2.1.7-1 describes the information flow for the IP connectivity group announcement request from the IOPS MC connectivity function at the IOPS MC system to the IOPS connectivity client at the MC UE. This IP connectivity group announcement request is used to announce the availability of MC users from a specific IOPS MC service group ID within the system. The availability only indicates the number of available discovered users from the IOPS MC service group ID.

TABLE 2.2.1.7-1
IP connectivity group announcement request

| Information | | |
|---|---|---|
| element | Status | Description |
| MC user ID | M | The MC ID associated to the IOPS MC service |
| | | group ID receiving the announcement request |
| IOPS group | M | The announcing IOPS MC service group ID for |
| | | which group connectivity information is being |
| | | provided |
| Group | M | It indicates the number of other discovered MC |
| connectivity | | users on the IOPS MC system associated to the |
| information | | corresponding IOPS MC service group ID |

### 4.1.1.8 IP connectivity group announcement response (from the IOPS connectivity client to the IOPS MC connectivity function)

Table 2.2.1.8-1 describes the information flow for the IP connectivity group announcement response from the IOPS connectivity client at the MC UE to the IOPS MC connectivity function at the IOPS MC system.

TABLE 2.2.1.8-1
IP connectivity group announcement response

| Information | | |
|---|---|---|
| element | Status | Description |
| MC user ID | M | The MC ID of the responding MC user |
| IOPS group | M | The IOPS MC service group ID for which |
| | | group connectivity information was received |

### 4.1.2 Procedures

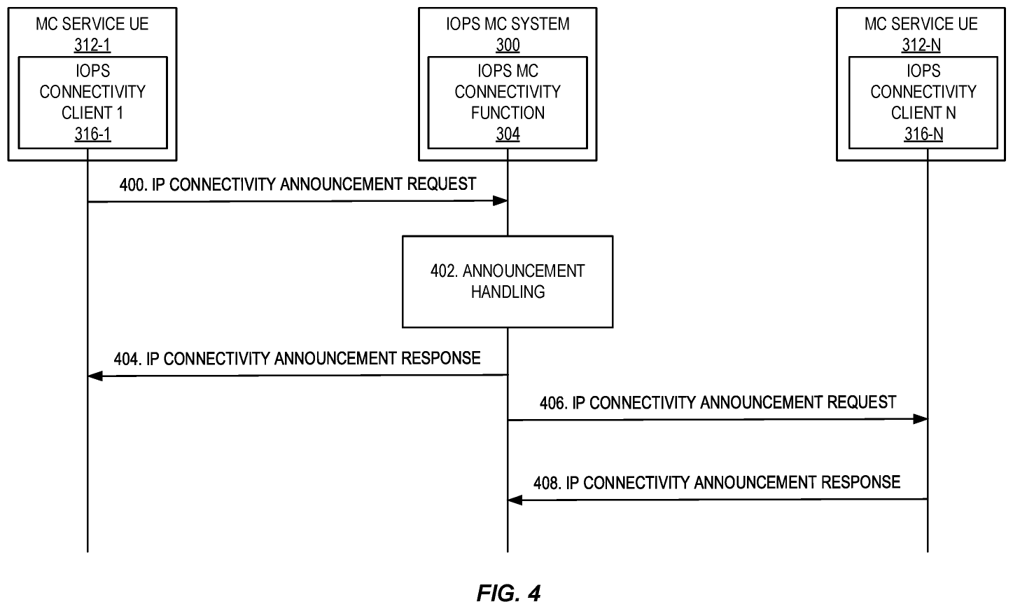

### FIG. 4

The procedure for the IP connectivity announcement from MC users in the IOPS mode of operation is described in FIG. 4. In this example of FIG. 2, there are two MC service UEs, denoted as MC service UE 312-1 and 312-N. Their respective IOPS connectivity clients are denoted as IOPS connectivity client 316-1 (also IOPS connectivity client 1) and IOPS connectivity client 316-N (also IOPS connectivity client N), respectively.

Pre-conditions:
The MC service users are discovered by the IOPS MC system.

The steps of the procedure of FIG. 4 are as follows:
Step 400: The IOPS connectivity client 316-1 (e.g., at MC UE 312-1) decides to announce its IP connectivity availability for one or more of its associated MC service IDs to other available MC UEs (e.g., MC UE 312-N) on the IOPS MC system 300. Therefore, it sends an IP connectivity announcement request to the IOPS MC connectivity function 304. The IOPS connectivity client 316-1 may also indicate that its IP connectivity availability announcement is only targeting a specific list of MC service IDs that may be within the system 300.
Step 402: The IOPS MC connectivity function 304 checks if the announcement request for the related MC service ID(s) can be accepted. If it does, the IP connectivity announcement request is transmitted to the related MC UE(s).
   NOTE 1: An announcement request can be accepted if, for example, the indicated MC service ID(s) from the requesting MC UE has been provided in its IOPS discovery request.
   NOTE 2: An IP connectivity announcement request implicitly indicates that the requesting MC UE's connectivity information can be made available to other MC UEs (or indicated targeted MC UEs) on the IOPS MC system 300.
Step 404: The IOPS MC connectivity function 304 provides, to the IOPS connectivity client 316-1, the announcement response for the related request.
Step 406: The IOPS MC connectivity function 304 transmits the IP connectivity announcement request to the related MC UE(s), which in this example include the MC UE 312-N.
Step 408: The IOPS connectivity client 316-N provides, to the IOPS MC connectivity function 304, the announcement response for the related request.

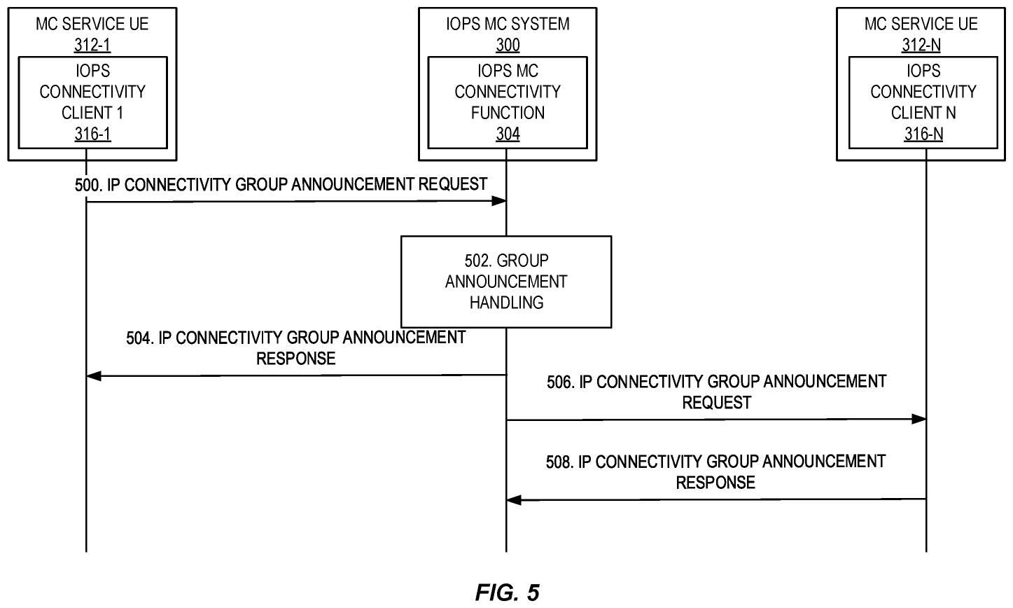

### FIG. 5

The procedure for the IP connectivity group announcement from MC UEs in the IOPS mode of operation is described in FIG. 5.

Pre-Conditions:
The MC service users are discovered by the IOPS MC system.
The MC service users have previously provided group IP connectivity information in the IOPS discovery request to the IOPS MC connectivity function.
It is assumed that the MC users related to the shown IOPS connectivity clients have been configured to belong to the same IOPS MC service group ID. This was then indicated within the group IP connectivity information in the IOPS discovery request to the IOPS MC connectivity function, respectively.

The steps of the procedure of FIG. 5 are as follows:
Step 500: The IOPS connectivity client 316-1 decides to announce its IP connectivity availability for one or more of its associated IOPS MC service group IDs to other available MC user group members on the IOPS MC system 300. Therefore, it sends an IP connectivity group announcement request to the IOPS MC connectivity function 304.
Step 502: The IOPS MC connectivity function 304 checks if the group announcement request for the related IOPS MC service group ID can be accepted. If it does, the IP connectivity group announcement request is transmitted to other MC UEs related to the corresponding IOPS MC service group ID(s).
   NOTE 1: A group announcement request can be accepted if the indicated IOPS MC service group ID(s) from the requesting MC UE 312-1 has been provided in its IOPS discovery request.
   NOTE 2: An IP connectivity group announcement request implicitly indicates that the requesting MC UE's connectivity information can be made available to other MC UEs (or indicated targeted MC UEs) on the IOPS MC system 300.
Step 504: The IOPS MC connectivity function 304 provides to the IOPS connectivity client 316-1 the group announcement response for the related request.
Step 506: The IOPS MC connectivity function 304 transmits the IP connectivity group announcement request to other MC UEs related to the corresponding IOPS MC service group ID(s), which in this example include the MC UE 312-N.
Step 508: The IOPS connectivity client 316-N provides to the IOPS MC connectivity function the group announcement response for the related request.

### 4.2 IP Connectivity Discovery

The support of the IP connectivity functionality in the IOPS mode of operation enables that MC services are provided by the MC service clients operating on the MC service UEs via the IOPS MC system. An IOPS MC system provides IP connectivity for the communication among MC service users based on an IOPS discovery procedure.

The IOPS discovery procedure enables that the IOPS MC system discovers MC service users and receives connectivity information to establish an IP connectivity communication between discovered users.

The following clauses specify the IOPS discovery procedure and information flows for the IP connectivity functionality in the IOPS mode of operation, in accordance with some example embodiments of the present disclosure.

### 4.2.1 Information Flows

### 4.2.1.1 IP Connectivity Request

Table 2.3.1.1-1 describes the information flow for the IP connectivity request from the IOPS connectivity client at the MC UE to the IOPS MC connectivity function at the IOPS MC system.

TABLE 2.3.1.1-1
IP connectivity request

| Information element | Status | Description |
|---|---|---|
| MC user ID (NOTE) | M | The MC ID of the user requesting |
| | | support of the IP connectivity |
| | | functionality |

NOTE:
The MC user ID can be a user identity to be used only in the IOPS mode of operation.

### 4.2.1.2 IP Connectivity Response

Table 2.3.1.2-1 describes the information flow for the IP connectivity response from the IOPS MC connectivity function to the IOPS connectivity client.

TABLE 2.3.1.2-1
IP connectivity response

| Information element | Status | Description |
|---|---|---|
| MC user ID | M | The MC ID of the user requesting |
| | | support of the IP connectivity |
| | | functionality |
| IP connectivity | M | It indicates if the IP connectivity |
| support | | functionality is supported or not |
| | | for the user |

### 4.2.1.3 IOPS Discovery Request

Table 2.3.1.3-1 describes the information flow for the IOPS discovery request from the IOPS connectivity client to the IOPS MC connectivity function.

TABLE 2.3.1.3-1
IOPS discovery request

| Information element | Status | Description |
|---|---|---|
| MC user ID (NOTE 1) | M | The MC ID of the user requesting to be discovered |
| List of MC service IDs | M | List of MC service IDs (e.g. MCPTT ID, MCData ID) |
| (NOTE 2) | | of the requesting MC user |
| IP connectivity information | M | It includes the requesting MC service UE’s IP |
| | | address assigned by the IOPS EPS for the IP |
| | | connectivity functionality |
| Group IP connectivity | O | It includes the list of IOPS groups (IOPS MC service |
| information | | group ID and its associated IOPS group IP multicast |
| | | address) the requesting MC user is configured with |
| | | (NOTE 3) |
| Availability of connectivity | O | It indicates if the connectivity information of the |
| information | | requesting MC user can be made available to other |
| | | users on the system |
| List of MC service IDs | O | The specific list of MC service IDs (e.g. MCPTT ID, |
| | | MCData ID) that the requesting MC user’s |
| | | connectivity information can be shared with |

NOTE 1:
The MC user ID can be a user identity to be used only in the IOPS mode of operation.
NOTE 2:
The MC service IDs can be service user identities to be used only in the IOPS mode of operation.
NOTE 3:
The list of IOPS groups (IOPS MC group ID and its associated IP multicast address) refers to the list of MC service groups for use by an MC service user in the IOPS mode of operation.

### 4.2.1.4 IOPS Discovery Response

Table 2.3.1.4-1 describes the information flow for the IOPS discovery response from the IOPS MC connectivity function to the IOPS connectivity client.

TABLE 2.3.1.4-1
IOPS discovery response

| Information element | Status | Description |
|---|---|---|
| MC user ID | M | The MC ID of the user requesting |
| | | to be discovered |
| Connectivity status | M | It indicates the connectivity status |
| | | of the requesting MC user on the |
| | | system |

### 4.2.2 Procedure

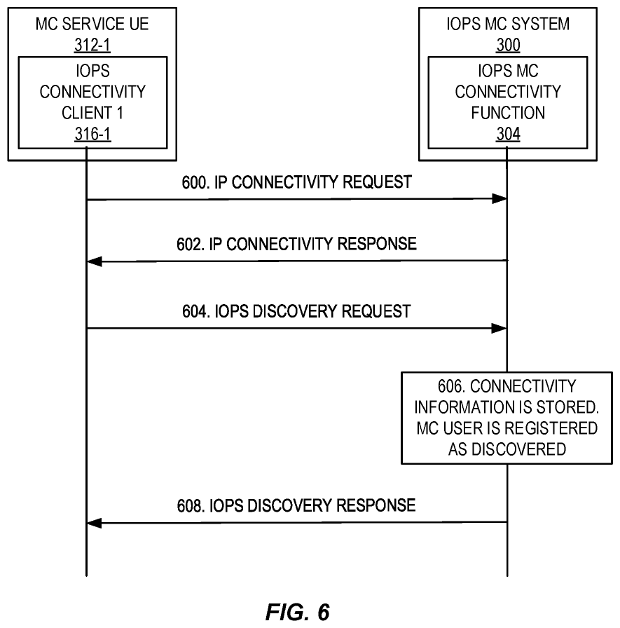

### FIG. 6

The procedure for the discovery of MC users in the IOPS mode of operation is described in FIG. 6. The IOPS discovery is initiated by the MC users to make use of the IP connectivity functionality.

Pre-conditions:
The MC service user is authenticated on the IOPS MC system.

The steps of the procedure of FIG. 6 are as follows:
Step 600. The IOPS connectivity client 316-1 at the MC UE 312-1 sends an IP connectivity request to the IOPS MC connectivity function 304 of the IOPS MC system 300. In this manner, the IOPS connectivity client 316-1 at the MC UE 312-1 requests to the IOPS MC connectivity function 304 the support of the IP connectivity functionality for the support of MC services.
Step 602. The IOPS MC connectivity function 304 sends an IP connectivity response to the IOPS connectivity client 316-1 that indicates to the MC UE 312-1 the support of the IP connectivity functionality for the support of MC services.
Step 604. The IOPS connectivity client 316-1 at the MC UE 312-1 sends an IOPS discovery request to the IOPS MC connectivity function 304. The request includes providing connectivity information for the support of MC services based on the IP connectivity functionality.
Step 606. The IOPS MC connectivity function 304 stores the information received from the MC UE 312-1 and registers the MC UE's connectivity status as discovered.
Step 608. The IOPS MC connectivity function 304 provides an IOPS discovery response to the IOPS connectivity client 316-1 indicating the success or failure of the discovery of the requesting MC UE 312-1.

### 4.3 IP Connectivity Subscription and Notification

The support of the IP connectivity functionality in the IOPS mode of operation enables that MC services are provided by the MC service clients operating on the MC service UEs via the IOPS MC system. An MC user that has been discovered by the IOPS MC system can subscribe to be notified about the connectivity information of other discovered MC users on the IOPS MC system. Also, a discovered MC user can subscribe to be notified about the number of other discovered MC users on the IOPS MC system from its associated IOPS groups.

The following clauses specify the IOPS subscription and notification procedures and information flows for the IP connectivity functionality in the IOPS mode of operation, in accordance with some example embodiments of the present disclosure.

### 4.3.1 Information Flows

### 4.3.1.1 IP Connectivity Subscribe Request

Table 2.4.1.1-1 describes the information flow for the IP connectivity subscribe request from the IOPS connectivity client to the IOPS MC connectivity function.

TABLE 2.4.1.1-1
IP connectivity subscribe request

| Information element | Status | Description |
|---|---|---|
| MC user ID | M | The MC ID of the requesting MC user |
| List of MC service IDs | O | List of MC service IDs (e.g. MCPTT ID, |
| (NOTE 1) | | MCData ID) the requesting MC user |
| | | subscribes to receive connectivity |
| | | information from |
| List of IOPS groups | O | List of IOPS groups (IOPS MC service |
| (NOTE 1 and NOTE 2) | | group IDs) the requesting MC user |
| | | subscribes to receive group connectivity |
| | | information from |

NOTE 1:
At least one should be present.
NOTE 2:
The IOPS group(s) should belong to the list of IOPS groups the requesting MC user included as part of the group IP connectivity information in the IOPS discovery request.

### 4.3.1.2 IP Connectivity Subscribe Response

Table 2.4.2.2-1 describes the information flow for the IP connectivity subscribe response from the IOPS MC connectivity function to the IOPS connectivity client.

TABLE 2.4.1.2-1
IP connectivity subscribe response

| Information element | Status | Description |
|---|---|---|
| MC user ID | M | The MC ID of the requesting MC user |
| Subscription status | M | It lists the subscription status, success |
| | | or failure, of the requested subscription(s) |

### 4.3.1.3 IP Connectivity Notify Request

Table 2.4.1.3-1 describes the information flow for the IP connectivity notify request from the IOPS MC connectivity function to the IOPS connectivity client.

TABLE 2.4.1.3-1
IP connectivity notify request

| Information | | |
|---|---|---|
| element | Status | Description |
| MC user ID | M | The MC ID of the MC user with active |
| | | subscription(s) |
| MC service ID | M | The MC service ID associated to the active |
| (NOTE) | | subscription for which connectivity information |
| | | is being notified |
| Connectivity | M | It provides connectivity information about the MC |
| information | | service ID of the corresponding subscription. It |
| (NOTE) | | includes the MC service UE’s IP address of the |
| | | associated MC service ID in the system |

NOTE:
It can be a list associated to multiple active subscriptions.

### 4.3.1.4 IP Connectivity Notify Response

Table 2.4.1.4-1 describes the information flow for the IP connectivity notify response from the IOPS connectivity client to the IOPS MC connectivity function.

TABLE 2.4.1.4-1
IP connectivity notify response

| Information element | Status | Description |
|---|---|---|
| MC user ID | M | The MC ID of the responding MC user |
| MC service ID | M | The MC service ID for which connectivity |
| (NOTE) | | information was received |

NOTE:
It can be a list associated to multiple active subscriptions.

### 4.3.1.5 IP Connectivity Group Notify Request

Table 2.4.1.5-1 describes the information flow for the IP connectivity group notify request from the IOPS MC connectivity function to the IOPS connectivity client.

TABLE 2.4.1.5-1
IP connectivity group notify request

| Information element | Status | Description |
|---|---|---|
| MC user ID | M | The MC ID of the MC user with active |
| | | subscription(s) |
| IOPS group (NOTE) | M | The IOPS MC service group ID related to the active |
| | | group subscription for which group connectivity |
| | | information is being notified |
| Group connectivity information | M | It indicates the number of other discovered MC |
| (NOTE) | | users on the IOPS MC system of the corresponding |
| | | group subscription |

NOTE:
It can be a list associated to multiple active group subscriptions.

### 4.3.1.6 IP Connectivity Group Notify Response

Table 2.4.1.6-1 describes the information flow for the IP connectivity group notify response from the IOPS connectivity client to the IOPS MC connectivity function.

TABLE 2.4.1.6-1
IP connectivity group notify response

| Information element | Status | Description |
|---|---|---|
| MC user ID | M | The MC ID of the responding MC user |
| IOPS group (NOTE) | M | The IOPS MC service group ID for which |
| | | group connectivity information was received |

NOTE:
It can be a list associated to multiple active group subscriptions.

### 4.3.2 Procedures

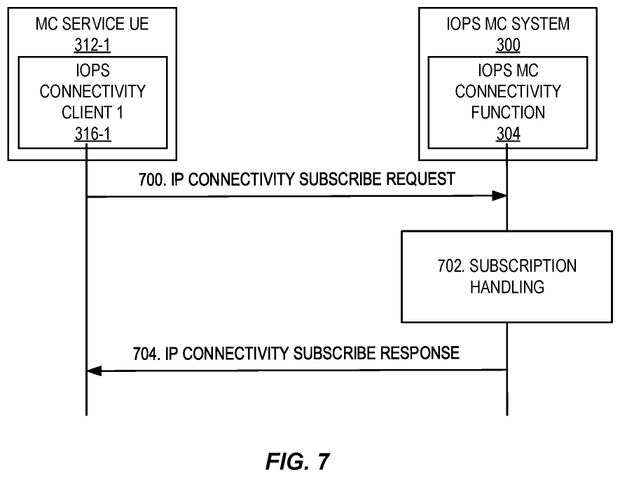

### FIG. 7

The procedure for the IP connectivity subscription of MC users in the IOPS mode of operation is described in FIG. 7.

Pre-conditions:
The MC service user is discovered by the IOPS MC system.
The MC service user has decided to subscribe to receive connectivity information of other discovered MC users and/or IOPS groups on the IOPS MC system.
For subscriptions associated to IOPS groups, the MC service user has previously provided group IP connectivity information in the IOPS discovery request to the IOPS MC connectivity function.

The steps of the procedure of FIG. 7 are as follows:
Step 700: The IOPS connectivity client 316-1 at the MC UE 312-1 subscribes to receive connectivity information of other discovered MC UEs and/or groups on the IOPS MC system 300. In other words, the IOPS connectivity client 316-1 at the MC UE 312-1 sends an IP connectivity subscribe request to the IOPS MC connectivity function 304 at the IOPS MC system 300.
Step 702: The IOPS MC connectivity function 304 checks if a subscription for the MC service ID(s) and/or IOPS group(s) included in the request can be activated for the requesting MC UE 312-1.
   NOTE: A subscription cannot be activated if an MC UE associated to the requested MC service ID has indicated in its IOPS discovery request that its connectivity information is not available to other users on the IOPS MC system. Besides, a subscription cannot be activated if a requested IOPS group doesn't belong to the list of IOPS groups the requesting MC user has included as part of the group IP connectivity information in the IOPS discovery request.
704: The IOPS MC connectivity function 304 indicates to the IOPS connectivity client 316-1 the subscription status associated to the request. In other words, the IOPS MC connectivity function 304 sends an IP connectivity subscribe response to the IOPS connectivity client 316-1 at the MC UE 312-1.

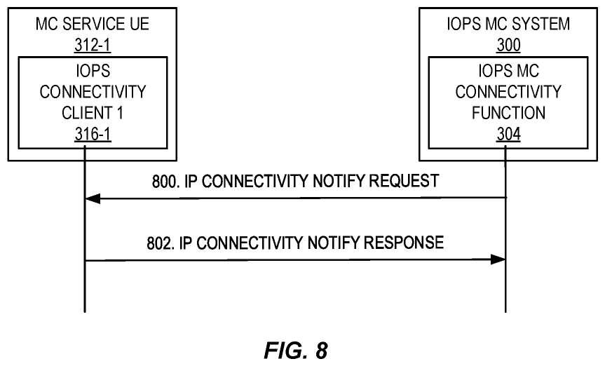

### FIG. 8

The procedure for the IP connectivity notification of MC users in the IOPS mode of operation is described in FIG. 8.

Pre-Conditions:
The MC service user has an active IP connectivity subscription associated to one or multiple MC service IDs.
The IOPS MC connectivity function has available information related to an IP connectivity subscription associated to one or multiple MC service IDs.

The steps of the procedure of FIG. 8 are as follows:
800: The IOPS MC connectivity function 304 at the IOPS MC system 300 notifies, to the IOPS connectivity client 316-1 at a MC UE 312-1, the connectivity information related to an active IP connectivity subscription associated to one or multiple MC service IDs. In other words, the IOPS MC connectivity function 304 sends an IP connectivity notify request to the IOPS connectivity client 316-1 at the MC UE 312-1. The connectivity information may be retrieved by the MC service client 314-1 at the MC UE 312-1 to establish an MC service communication based on the IP connectivity functionality.

802: The IOPS connectivity client 316-1 provides an IP connectivity notify response to the IOPS MC connectivity function 304.

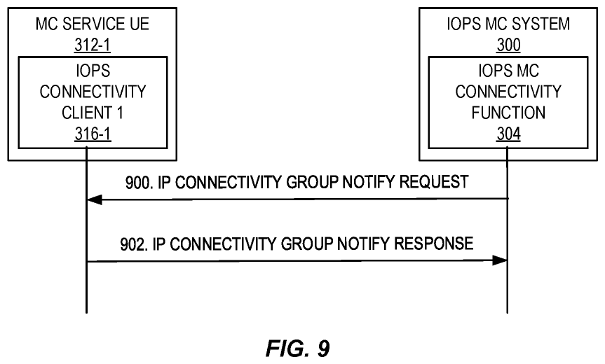

### FIG. 9

The procedure for the IP connectivity group notification of MC users in the IOPS mode of operation is described in FIG. 9.

Pre-Conditions:
The MC service user has an active IP connectivity subscription associated to one or multiple IOPS MC service group IDs.
The IOPS MC connectivity function has available information related to an IP connectivity subscription associated to one or multiple IOPS MC service group IDs.

The steps of the procedure of FIG. 9 are as follows:
900: The IOPS MC connectivity function 304 at the IOPS MC system 300 notifies, to the IOPS connectivity client 316-1 at a MC UE 312-1, the group connectivity information related to an active IP connectivity group subscription associated to one or multiple IOPS MC service group IDs. In other words, the IOPS MC connectivity function 304 sends an IP connectivity group notify request to the IOPS connectivity client 316-1 at the MC UE 312-1. The group connectivity information may be retrieved by the MC service client 314-1 to establish an MC service group communication based on the IP connectivity functionality.
902: The IOPS connectivity client 316-1 provides an IP connectivity group notify response to the IOPS MC connectivity function 304.

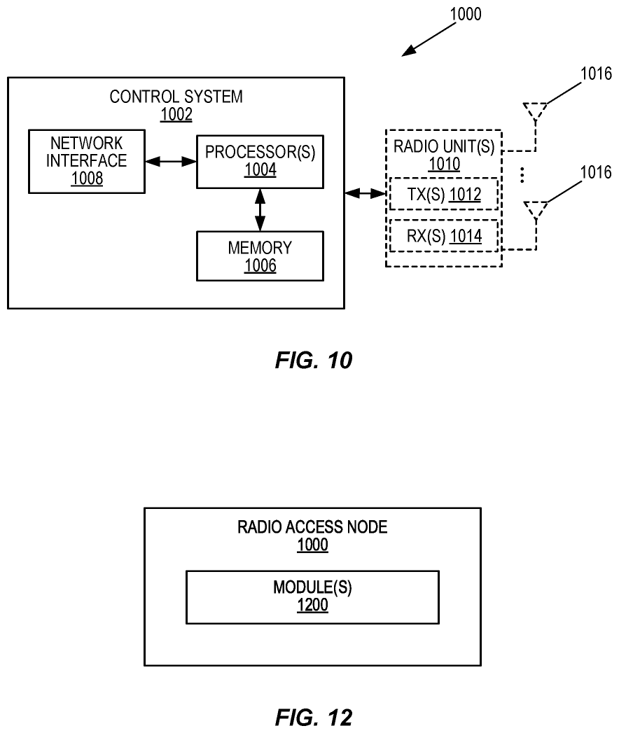

### FIG. 10

FIG. 10 is a schematic block diagram of a radio access node 1000 according to some embodiments of the present disclosure. Optional features are represented by dashed boxes. The radio access node 1000 may be, for example, a base station 202 or 206 or a network node that implements all or part of the functionality of the base station 202 or gNB described herein. In particular, all or part of the functionality of the IOPS MC system 300 described above (e.g., with respect to FIGS. 4 through 9) may be implemented in the radio access node 1000, in some embodiments. As illustrated, the radio access node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the radio access node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a radio access node 1000 as described herein. In some embodiments, the function(s) are implemented in software that is stored, e.g., in the memory 1006 and executed by the one or more processors 1004.

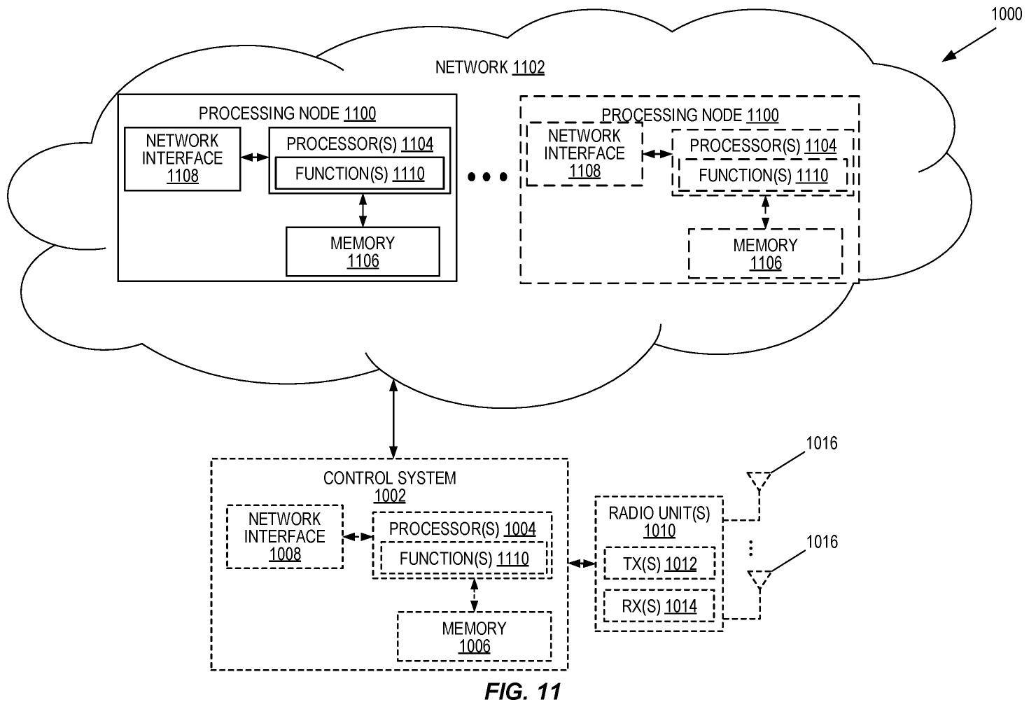

### FIG. 11

FIG. 11 is a schematic block diagram that illustrates a virtualized embodiment of the radio access node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1000 in which at least a portion of the functionality of the radio access node 1000 is implemented as a virtual component(s) (e.g., via a virtual machine(s) executing on a physical processing node(s) in a network(s)). As illustrated, in this example, the radio access node 1000 may include the control system 1002 and/or the one or more radio units 1010, as described above. The control system 1002 may be connected to the radio unit(s) 1010 via, for example, an optical cable or the like. The radio access node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the radio access node 1000 described herein (e.g., all or part of the functionality of the IOPS MC system 300 described above (e.g., with respect to FIGS. 4 through 9)) are implemented at the one or more processing nodes 1100 or distributed across the one or more processing nodes 1100 and the control system 1002 and/or the radio unit(s) 1010 in any desired manner. In some particular embodiments, some or all of the functions 1110 of the radio access node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of radio access node 1000 or a node (e.g., a processing node 1100) implementing one or more of the functions 1110 of the radio access node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 12

FIG. 12 is a schematic block diagram of the radio access node 1000 according to some other embodiments of the present disclosure. The radio access node 1000 includes one or more modules 1200, each of which is implemented in software. The module(s) 1200 provide the functionality of the radio access node 1000 described herein (e.g., all or part of the functionality of the IOPS MC system 300 described above (e.g., with respect to FIGS. 4 through 9)). This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

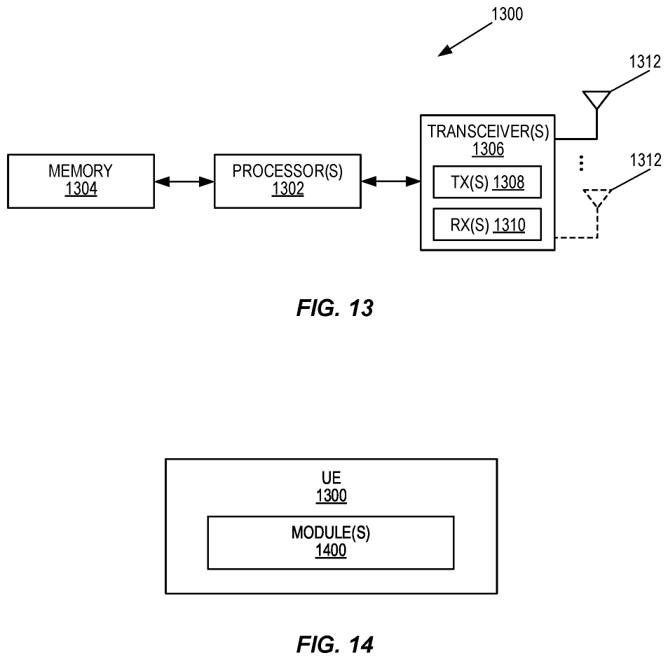

### FIG. 13

FIG. 13 is a schematic block diagram of a wireless communication device 1300 according to some embodiments of the present disclosure. The wireless communication device 1300 is one example of the wireless communication device 212. In some embodiments, the wireless communication device 1300 is a MC service device (e.g., a MC service UE 312). As illustrated, the wireless communication device 1300 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the wireless communication device 1300 described above (e.g., all or part of the functionality the MC service UE described above with respect to, e.g., FIGS. 4 to 9) may be fully or partially implemented in software that is, e.g., stored in the memory 1304 and executed by the processor(s) 1302. Note that the wireless communication device 1300 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the wireless communication device 1300 and/or allowing output of information from the wireless communication device 1300), a power supply (e.g., a battery and associated power circuitry), etc.

In some embodiments, a computer program including instructions which, when executed by at least one processor, causes the at least one processor to carry out the functionality of the wireless communication device 1300 according to any of the embodiments described herein (e.g., all or part of the functionality the MC service UE 312-1 or 312-N described above with respect to, e.g., FIGS. 4 to 9) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 14

FIG. 14 is a schematic block diagram of the wireless communication device 1300 according to some other embodiments of the present disclosure. The wireless communication device 1300 includes one or more modules 1400, each of which is implemented in software. The module(s) 1400 provide the functionality of the wireless communication device 1300 described herein (e.g., all or part of the functionality the MC service UE 312-1 or 112-N described above with respect to, e.g., FIGS. 4 to 9).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some of the embodiments described above may be summarized in the following manner:

### 5 SOME EMBODIMENTS

1. [FIG. 4 or 5—IP connectivity announcement or IP connectivity group announcement from IOPS connectivity client 1 perspective] A method performed by a wireless communication device (312-1), the method comprising:
sending (400; 500), to an isolated operation for public safety, IOPS, mission critical, MC, system (300) associated with one or more radio access nodes (202, 206) of a cellular communications system (200), an Internet Protocol, IP, connectivity announcement request or an IP connectivity group announcement request for announcing availability of the wireless device to one or more other devices (312-N) served by the IOPS MC system; and
receiving (404; 504), from the IOPS MC system, an IP connectivity announcement response or an IP connectivity group announcement response.

2. The method of embodiment 1 wherein sending (400; 500) comprises sending (400) the IP connectivity announcement request, the IP connectivity announcement request comprising:
an identifier of the wireless communication device (212, 1300); and
one or more MC service identifiers associated with the wireless communication device to be announced as being available to other MC service enabled wireless communication devices.

2A. The method of embodiment 1 wherein sending (400; 500) comprises sending (400) the IP connectivity announcement request, the IP connectivity announcement request comprising:
an identifier of the wireless communication device (212, 1300); and
one or more MC service user identifiers associated with the wireless communication device to be announced as being available to other MC service enabled wireless communication devices.

3. The method of embodiment 2 wherein the IP connectivity announcement request further comprises one or more target MC service identifiers to which IP connectivity information for the wireless communication device (212, 1300) is to be announced.

3A. The method of embodiment 2A wherein the IP connectivity announcement request further comprises one or more target MC service user identifiers to which IP connectivity information for the wireless communication device (212, 130 ) is to be announced.

4. The method of any of embodiments 2 to 3A wherein the other MC service enabled wireless communication devices are at least some other MC service enabled wireless communication devices that are discovered by the IOPS MC system.

5. The method of any of embodiments 2 to 4 wherein receiving (404; 504) comprises receiving (404) the IP connectivity announcement response, the IP connectivity announcement response comprising:
an identifier of the wireless communication device (212, 1300); and
one or more MC service identifiers associated with the wireless communication device or one or more MC service user identifiers associated with the wireless communication device, for which the IP connectivity announcement request is accepted by the IOPS MC system.

6. The method of embodiment 5 wherein the IP connectivity announcement response further comprises one or more target MC service identifiers or one or more target MC service user identifiers, for which the IP connectivity announcement request is accepted by the IOPS MC system.

7. The method of embodiment 1 wherein sending (400; 500) comprises sending (500) the IP connectivity group announcement request, the IP connectivity group announcement request comprising:
an identifier of the wireless communication device (212, 1300); and
information that identifies one or more MC service groups for which the wireless communication device (212, 1300) intends to announce its availability on the IOPS MC system.

8. The method of embodiment 7 wherein receiving (404; 504) comprises receiving (504) the IP connectivity group announcement response, the IP connectivity group announcement response comprising:
an identifier of the wireless communication device (212, 1300); and
information that identifies one or more MC service groups for which the IP connectivity group announcement request is accepted by the IOPS MC system.

9. [FIG. 4 or 5—IP connectivity announcement or IP connectivity group announcement from IOPS MC systemlconnectivity function perspective] A method performed by IOPS, mission critical, MC, system associated with one or more radio access nodes (202, 206) of a cellular communications system (200), the method comprising:
receiving (400; 500), from a first wireless communication device (212, 1300), an Internet Protocol, IP, connectivity announcement request or an IP connectivity group announcement request; and
sending (404; 504), to the first wireless communication device (212, 1300), an IP connectivity announcement response or an IP connectivity group announcement response.

10. The method of embodiment 9 wherein receiving (400; 500) comprises receiving (400) the IP connectivity announcement request, sending (404; 504) comprises sending the IP connectivity announcement response, and the method further comprises processing (402) the IP connectivity announcement request to determine whether to accept the IP connectivity announcement request and/or to determine MC services identifiers for which to accept the IP connectivity announcement request, wherein the IP connectivity announcement response comprises information that reflects a result of the processing (402).

11. The method of embodiment 9 or 10 wherein receiving (400; 500) comprises receiving (400) the IP connectivity announcement request, the IP connectivity announcement request comprising:
an identifier of the first wireless communication device (212, 1300); and
one or more MC service identifiers associated with the first wireless communication device or one or more MC service user identifiers associated with the first wireless communication device, to be announced as being available to other MC service enabled wireless communication devices.

12. The method of embodiment 11 wherein the IP connectivity announcement request further comprises one or more target MC service identifiers or one or more target MC service user identifiers, to which IP connectivity information for the first wireless communication device (212, 1300) is to be announced.

13. The method of embodiment 11 or 12 wherein the other MC service enabled wireless communication devices are at least some other MC service enabled wireless communication devices that are discovered by the IOPS MC system.

14. The method of any of embodiments 9 to 13 wherein sending (404; 504) comprises sending (404) the IP connectivity announcement response, the IP connectivity announcement response comprising:
an identifier of the first wireless communication device (212, 1300); and
one or more MC service identifiers or one or more MC service user identifiers, for which the IP connectivity announcement request is accepted by the IOPS MC system.

15. The method of embodiment 14 wherein the IP connectivity announcement response further comprises one or more target MC service identifiers or one or more target MC service user identifiers, for which the IP connectivity announcement request is accepted by the IOPS MC system.

16. The method of embodiment 9 or 10 wherein receiving (400; 500) comprises receiving (500) the IP connectivity group announcement request, the IP connectivity group announcement request comprising:
an identifier of the wireless communication device (212, 1300); and
information that identifies one or more MC service groups for which the wireless communication device (212, 1300) intends to announce its availability on the IOPS MC system.

17. The method of embodiment 16 wherein sending (404; 504) comprises sending (504) the IP connectivity group announcement response, the IP connectivity group announcement response comprising:
an identifier of the wireless communication device (212, 1300); and
information that identifies one or more MC service groups for which the IP connectivity group announcement request is accepted by the IOPS MC system.

18. The method of any of embodiments 9 to 17 further comprising:
sending (406; 506), to a second wireless communication device, an IP connectivity announcement request or an IP connectivity group announcement request; and
receiving (408; 508), from the second wireless communication device, an IP connectivity announcement response or an IP connectivity group announcement response.

19. The method of embodiment 18 wherein sending (406; 506) comprises sending (406) the IP connectivity announcement request to the second wireless communication device, the IP connectivity announcement request sent to the second wireless communication device comprising:
an identifier of the second wireless communication device;
connectivity information for the first wireless communication device; and
a MC service identifier or a MC service user identifier, for which the connectivity information is being provided.

20. The method of embodiment 19 wherein the connectivity information comprises an IP address of the first wireless communication device.

21. The method of any of embodiments 18 to 20 wherein receiving (408; 508) comprises receiving (408) the IP connectivity announcement response from the second wireless communication device, the IP connectivity announcement response received from the second wireless communication device comprising:
an identifier of the second wireless communication device; and
a MC service identifier or a MC service user identifier, for which the connectivity information was received.

22. The method of embodiment 18 wherein sending (406; 506) comprises sending (506) the IP connectivity group announcement request to the second wireless communication device, the IP connectivity group announcement request sent to the second wireless communication device comprising:
an identifier of the second wireless communication device;
group connectivity information; and
a MC service identifier or a MC service user identifier, for which the group connectivity information is being provided.

23. The method of embodiment 22 wherein the group connectivity information indicates a number of other discovered MC service enabled wireless communication devices on the IOPS MC system in the MC service group.

24. The method of embodiment 22 or 23 wherein receiving (408; 508) comprises receiving (508) the IP connectivity group announcement response from the second wireless communication device, the IP connectivity group announcement response received from the second wireless communication device comprising:
an identifier of the second wireless communication device; and
information that identifies a MC service group for which the group connectivity information was received.

25. [FIG. 6—IP connectivity discovery from IOPS connectivity client 1 perspective] A method performed by a wireless communication device (212, 1300), the method comprising:
sending (604), to an isolated operation for public safety, IOPS, mission critical, MC, system associated with one or more radio access nodes (202, 206) of a cellular communications system (200), an IOPS discovery request; and
receiving (606), from the IOPS MC system, an IOPS discovery response.

26. The method of embodiment 25 wherein the IOPS discovery request comprises:
an identifier of the wireless communication device (212, 1300); and
one or more MC service identifiers associated with the wireless communication device (212; 1300) or one or more MC service user identifiers associated with the wireless communication device (212; 1300); and
connectivity information for the wireless communication device (212; 1300).

27. The method of embodiment 26 wherein the connectivity information comprises an Internet Protocol, IP, address assigned to the wireless communication device (212; 1300) in an IOPS cellular communications system (e.g., an IOPS EPS) for IP connectivity functionality.

28. The method of embodiment 26 or 27 wherein the IOPS discovery request further comprises:
group connectivity information;
information that indicates whether the connectivity information of the wireless communication device can be made available to other wireless communication devices on the IOPS MC system; and/or
one or more MC service identifiers or one or more MC service user identifiers, with which the connectivity information of the wireless communication device (212; 1300) can be shared.

29. The method of any of embodiments 25 to 28 wherein the IOPS discovery response comprises:
an identifier of the wireless communication device (212, 1300); and
information that identifies a connectivity status (e.g., available or unavailable) of the wireless communication device (212; 1300) on the IOPS MC system.

30. [FIG. 6—IP connectivity discovery from IOPS MC system I connectivity function perspective] A method performed by an isolated operation for public safety, IOPS, mission critical, MC, system associated with one or more radio access nodes (202, 206) of a cellular communications system (200), the method comprising:
receiving (604), from a wireless communication device (212, 1300), an IOPS discovery request; and
sending (606), to the wireless communication device (212, 1300), an IOPS discovery response.

31. The method of embodiment 30 wherein the IOPS discovery request comprises:
an identifier of the wireless communication device (212, 1300); and
one or more MC service identifiers or one or more MC service user identifiers, associated with the wireless communication device (212; 1300); and
connectivity information for the wireless communication device (212; 1300).

32. The method of embodiment 31 wherein the connectivity information comprises an Internet Protocol, IP, address assigned to the wireless communication device (212; 1300) in an IOPS cellular communications system (e.g., an IOPS EPS) for IP connectivity functionality.

33. The method of embodiment 31 or 32 wherein the IOPS discovery request further comprises:
group connectivity information;
information that indicates whether the connectivity information of the wireless communication device can be made available to other wireless communication devices on the IOPS MC system; and/or
one or more MC service identifiers or one or more MC service user identifiers, associated with wireless communication devices with which the connectivity information of the wireless communication device (212; 1300) can be shared.

34. The method of any of embodiments 30 to 33 wherein the IOPS discovery response comprises:
an identifier of the wireless communication device (212, 1300); and
information that identifies a connectivity status (e.g., available or unavailable) of the wireless communication device (212; 1300) on the IOPS MC system.

35. The method of any of embodiments 30 to 34 further comprising storing the connectivity information of the wireless communication device (212; 1300) and registering the wireless communication device (212; 1300) as being discovered.

36. [FIG. 7—IP connectivity subscribe from IOPS connectivity client perspective] A method performed by a wireless communication device (212, 1300), the method comprising:
sending (700), to an isolated operation for public safety, IOPS, mission critical, MC, system associated with one or more radio access nodes (202, 206) of a cellular communications system (200), an IP connectivity subscribe request; and
receiving (704), from the IOPS MC system, an IP connectivity subscribe response.

37. The method of embodiment 36 wherein the IP connectivity subscribe request comprises:
an identifier of the wireless communication device (212; 1300); either or both of:
one or more MC service identifiers or one or more MC service user identifiers, for which the wireless communication device (212; 1300) desires to subscribe to receive connectivity information;
information that identifies one or more MC service groups for which the wireless communication device (212; 1300) desires to subscribe to receive group connectivity information.

38. The method of embodiment 36 or 37 wherein the IP connectivity subscribe response comprises:
an identifier of the wireless communication device (212; 1300); and
information that indicates a subscription status of the wireless communication device (212; 1300).

39. [FIG. 7—IP connectivity subscribe from IOPS MC service perspective] A method performed by an isolated operation for public safety, IOPS, mission critical, MC, system associated with one or more radio access nodes (202, 206) of a cellular communications system (200), the method comprising:
receiving (700), from a wireless communication device (212, 1300), an IP connectivity subscribe request; and
sending (704), to the wireless communication device (212, 1300), an IP connectivity subscribe response.

40. The method of embodiment 39 wherein the IP connectivity subscribe request comprises:
an identifier of the wireless communication device (212; 1300);
either or both of:
   one or more MC service identifiers or one or more MC service user identifiers, for which the wireless communication device (212; 1300) desires to subscribe to receive connectivity information;
   information that identifies one or more MC service groups for which the wireless communication device (212; 1300) desires to subscribe to receive group connectivity information.

41. The method of embodiment 39 or 40 wherein the IP connectivity subscribe response comprises:
an identifier of the wireless communication device (212; 1300); and
information that indicates a subscription status of the wireless communication device (212; 1300).

42. [FIG. 8 or 9—IP connectivity notify requestlresponse or IP connectivity group notify requestlresponse from IOPS connectivity client 1 perspective] A method performed by a wireless communication device (212, 1300), the method comprising:
receiving (800; 900), from an isolated operation for public safety, IOPS, mission critical, MC, system associated with one or more radio access nodes (202, 206) of a cellular communications system (200), an Internet Protocol, IP, connectivity notify request or an IP connectivity group notify request; and
sending (802; 902), to the IOPS MC system, an IP connectivity notify response or an IP connectivity group notify response.

43. The method of embodiment 42 wherein receiving (800; 900) comprises receiving (800) the IP connectivity notify request, the IP connectivity notify request comprising:
an identifier of the wireless communication device (212; 1300);
a MC service identifier or MC service user identifier, for which connectivity information is being notified to the wireless communication device (212; 1300); and
connectivity information for the MC service identifier or MC service user identifier.

44. The method of embodiment 43 wherein the connectivity information comprises an IP address of an associated MC service enabled wireless communication device.

45. The method of any of embodiments 42 to 44 wherein sending (802; 902) comprises sending (802) the IP connectivity notify response, the IP connectivity notify response comprises:
an identifier of the wireless communication device (212; 1300); and
a MC service identifier or MC service user identifier, for which connectivity information was received in the request.

46. The method of embodiment 42 wherein receiving (800; 900) comprises receiving (900) the IP connectivity group notify request, the IP connectivity group notify request comprising:
an identifier of the wireless communication device (212; 1300);
information that identifies a MC service group for which group connectivity information is being notified to the wireless communication device (212; 1300); and
group connectivity information for the identified MC service group.

47. The method of embodiment 46 wherein the group connectivity information comprises information that indicates a number of other discovered MC service enabled wireless communication devices for the corresponding group subscription.

48. The method of any of embodiments 42 to 47 wherein sending (802; 902) comprises sending (902) the IP connectivity group notify response, the IP connectivity notify response comprising:
an identifier of the wireless communication device (212; 1300); and
information that identifies a MC service group for which group connectivity information was received in the request.

49. [FIG. 8 or 9—IP connectivity notify requestlresponse or IP connectivity group notify requestlresponse from IOPS MC system perspective] A method performed by an isolated operation for public safety, IOPS, mission critical, MC, system associated with one or more radio access nodes (202, 206) of a cellular communications system (200), the method comprising:
sending (800; 900), to a wireless communication device (212, 1300), an Internet Protocol, IP, connectivity notify request or an IP connectivity group notify request; and
receiving (802; 902), from the wireless communication device (212, 1300), an IP connectivity notify response or an IP connectivity group notify response.

50. The method of embodiment 49 wherein sending (800; 900) comprises sending (800) the IP connectivity notify request, the IP connectivity notify request comprising:
an identifier of the wireless communication device (212; 1300);
a MC service identifier or MC service user identifier, for which connectivity information is being notified to the wireless communication device (212; 1300); and
connectivity information for the identified MC service identifier or MC service user identifier.

51. The method of embodiment 50 wherein the connectivity information comprises an IP address of an associated MC service enabled wireless communication device.

52. The method of any of embodiments 49 to 51 wherein receiving (802; 902) comprises receiving (802) the IP connectivity notify response, the IP connectivity notify response comprises:
an identifier of the wireless communication device (212; 1300); and
a MC service identifier or MC service user identifier, for which connectivity information was received in the request.

53. The method of embodiment 49 wherein sending (800; 900) comprises sending (900) the IP connectivity group notify request, the IP connectivity group notify request comprising:
an identifier of the wireless communication device (212; 1300);
information that identifies a MC service group for which group connectivity information is being notified to the wireless communication device (212; 1300); and
group connectivity information for the identified MC service group.

54. The method of embodiment 53 wherein the group connectivity information comprises information that indicates a number of other discovered MC service enabled wireless communication devices for the corresponding group subscription.

55. The method of any of embodiments 49 to 54 wherein receiving (802; 902) comprises receiving (902) the IP connectivity group notify response, the IP connectivity group notify response comprising:
an identifier of the wireless communication device (212; 1300); and
information that identifies a MC service group for which group connectivity information was received in the request.

56. A wireless communication device (212; 1300) adapted to perform the method of any of embodiments 1-8, 25-29, 36-38, and 42-48.

57. A wireless communication device (212; 1300) comprising:
one or more transmitters (1308);
one or more receivers (1310); and
processing circuitry (1302) associated with the one or more transmitters (1308) and the one or more receivers (1310), the processing circuitry (1302) configured to cause the wireless communication device (212; 1300) to perform the method of any of embodiments 1-8, 25-29, 36- 38, and 42-48.

58. An isolated operation for public safety, IOPS, mission critical, MC, system associated with one or more radio access nodes (202, 206) of a cellular communications system (200), IOPS MC system adapted to perform the method of any of embodiments 9-24, 30-35, 39-41, and 49-55.

59. A node that implements an isolated operation for public safety, IOPS, mission critical, MC, system associated with one or more radio access nodes (202, 206) of a cellular communications system (200), the node comprising:
processing circuitry (1004; 1104) configured to cause the node to implement the IOPS MC system such that the IOPS MC system performs the method of any of embodiments 9-24, 30-35, 39-41, and 49- 55.

### 6 ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
3G Third Generation
3GPP Third Generation Partnership Project
4G Fourth Generation
5G Fifth Generation
AF Application Function
AMF Access and Mobility Management Function
AN Access Network
AP Access Point
AUSF Authentication Server Function
BCCH Broadcast Control Channel
BCH Broadcast Channel
BS Base Station
BSC Base Station Controller
BTS Base Transceiver Station
CDMA Code Division Multiple Access
CGI Cell Global Identifier
D2D Device-to-Device
DL Downlink
DN Data Network
ECGI Evolved Cell Global Identifier
eNB Enhanced or Evolved Node B
E-UTRA Evolved Universal Terrestrial Radio Access
E-UTRAN Evolved Universal Terrestrial Radio Access Network
GERAN Global System for Mobile (GSM) Communications Enhanced Data Rates for GSM Evolution Radio Access Network
gNB New Radio Base Station
GSM Global System for Mobile Communications
HO Handover
HSPA High Speed Packet Access
IOPS Isolated Operation for Public Safety
IP Internet Protocol
LAN Local Area Network
LTE Long Term Evolution
MBMS Multimedia Broadcast Multicast Services
MBSFN Multimedia Broadcast Multicast Service Single Frequency Network
MC Mission Critical
MIB Master Information Block
MME Mobility Management Entity
MSC Mobile Switching Center
NF Network Function
NR New Radio
NRF Network Function Repository Function
NSSF Network Slice Selection Function
OFDM Orthogonal Frequency Division Multiplexing
OFDMA Orthogonal Frequency Division Multiple Access
SCEF Service Capability Exposure Function
S-GW Serving Gateway
SI System Information
SIB System Information Block
SMF Session Management Function
TCP Transmission Control Protocol
TDD Time Division Duplexing
UDM Unified Data Management
UE User Equipment
UL Uplink
UMTS Universal Mobile Telecommunications System
USIM Universal Subscriber Identity Module
UTRA Universal Terrestrial Radio Access
UTRAN Universal Terrestrial Radio Access Network
WCDMA Wideband Code Division Multiple Access
WLAN Wireless Local Area Network

### 7 APPENDIX

### 3GPP TSG-SA WG6 Meeting #34 S6-192xxx

Reno, Nev., USA, 11^{th}-15^{th} Nov. 2019 (revision of S6-19xxxx)

### Source: Ericsson

Title: Pseudo-CR on IOPS announcement

### Spec: 3GPP TS 23.180 v0.1.0

Agenda item: 10.2

### Document for: Approval

Contact: Camilo Solano (camilo.solano@ericsson.com)

1. Introduction

The IP connectivity functionality in the IOPS mode of operation includes procedures for the announcement of the availability of a user on the system. Thus, a user can request that its availability is announced to other user(s) within the IOPS MC system.

2. Reason for Change

Definition of the IOPS announcement procedures to be used for the MC services support based on IP connectivity in the IOPS mode of operation.

3. Conclusions

<Conclusion part (optional)>4. Proposal

It is proposed to approve the following changes to 3GPP TS 23.180 v0.1.0.

### First Change

### 10.X IP Connectivity Functionality: IOPS Announcement

### 10.x.1 General

The support of the IP connectivity functionality in the IOPS mode of operation enables that MC services are provided by the MC service clients operating on the MC service UEs via the IOPS MC system. An MC user that has been discovered by the IOPS MC system can request to the IOPS MC connectivity function to announce to other discovered MC users its connectivity information on the system. This announcement message can be transmitted to other MC users on the system, although, those MC users haven't subscribed to.

The following clauses specify the IOPS announcement procedures and information flows for the IP connectivity functionality in the IOPS mode of operation.

### 10.x.2 Information Flows10.x.2.1 IP Connectivity Announcement Request (From the IOPS Connectivity Client to the IOPS MC Connectivity Function)

Table 10.x.2.1-1 describes the information flow for the IP connectivity announcement request from the IOPS connectivity client to the IOPS MC connectivity function. This IP connectivity announcement request is used to announce a specific MC service ID(s) within the system.

TABLE 10.x.2.1-1
IP connectivity announcement request

| Information element | Status | Description |
|---|---|---|
| MC user ID | M | The MC ID of the requesting MC user |
| List of MC service IDs | M | it provides the specific list of MC service IDs |
| | | (e.g. MCPTT ID, MCData ID) from the requesting |
| | | MC user to be announced as available to other MC |
| | | users on the system |
| List of MC service IDs | O | It provides a specific target list of MC service IDs |
| (NOTE) | | (e.g. MCPTT ID, MCData ID) to announce the |
| | | requesting MC user’s connectivity information |

NOTE:
There is a match between the MC service IDs list from the requesting MC user and the targeted MC service IDs, i.e. a requesting MC service ID is requested to be announced to specific targeted MC service ID(s) from the same MC service.

### 10.x.2.2 IP Connectivity Announcement Response (From the IOPS MC Connectivity Function to the IOPS Connectivity Client)

Table 10.x.2.2-1 describes the information flow for the IP connectivity announcement response from the IOPS MC connectivity function to the IOPS connectivity client.

TABLE 10.x.2.2-1
IP connectivity announcement response

| Information element | Status | Description |
|---|---|---|
| MC user ID | M | The MC ID of the requesting MC user |
| List of MC service IDs | M | It lists the MC service IDs from the requesting MC |
| | | user for which the announcement request was |
| | | accepted |
| List of MC service IDs | O | it lists the targeted MC service IDs for which the |
| (NOTE) | | corresponding requesting MC user’s MC service ID |
| | | announcement request was accepted |

NOTE:
There is a match between the MC service IDs list from the requesting MC user and the targeted MC service IDs.

### 10.x.2.3 IP Connectivity Announcement Request (From the IOPS MC Connectivity Function to the IOPS Connectivity Client)

Table 10.x.2.3-1 describes the information flow for the IP connectivity announcement request from the IOPS MC connectivity function to the IOPS connectivity client. This IP connectivity announcement request is used to announce a specific MC service ID(s) within the system.

TABLE 10.x.2.3-1
IP connectivity announcement request

| Information | | |
|---|---|---|
| element | Status | Description |
| MC user ID | M | The MC ID associated to the MC service ID |
| | | receiving the announcement request |
| MC service ID | M | The announcing MC service ID for which |
| | | connectivity information is being provided |
| Connectivity | M | It provides the connectivity information of the |
| information | | announcing MC service ID. It includes the MC |
| | | service UE’s IP address of the announcing MC |
| | | service ID in the system |

### 10.x.2.4 IP Connectivity Announcement Response (from the IOPS Connectivity Client to the IOPS MC Connectivity Function)

Table 10.x.2.4-1 describes the information flow for the IP connectivity announcement response from the IOPS connectivity client to the IOPS MC connectivity function.

TABLE 10.x.2.4-1
IP connectivity announcement response

| Information | | |
|---|---|---|
| element | Status | Description |
| MC user ID | M | The MC ID of the responding MC user |
| MC service ID | M | The MC service ID for which connectivity |
| | | information was received |

### 10.x.2.5 IP Connectivity Group Announcement Request (from the IOPS Connectivity Client to the IOPS MC Connectivity Function)

Table 10.x.2.5-1 describes the information flow for the IP connectivity group announcement request from the IOPS connectivity client to the IOPS MC connectivity function. This IP connectivity group announcement request is used to announce the availability of MC users from specific IOPS MC service group IDs within the system. The availability only indicates the number of available discovered users from an IOPS MC group ID.

TABLE 10.x.2.5-1
IP connectivity group announcement request

| Information | | |
|---|---|---|
| element | Status | Description |
| MC user ID | M | The MC ID of the requesting MC user |
| List of IOPS | M | It provides a specific list of IOPS MC |
| groups | | service group IDs for which the |
| (NOTE) | | requesting MC user intends to |
| | | announce its availability on the system |

NOTE:
The listed IOPS groups belong to the requesting MC user’s IOPS groups list indicated in the IOPS discovery request.

### 10.x.2.6 IP Connectivity Group Announcement Response (from the IOPS MC Connectivity Function to the IOPS Connectivity Client)

Table 10.x.2.6-1 describes the information flow for the IP connectivity group announcement response from the IOPS MC connectivity function to the IOPS connectivity client.

TABLE 10.x.2.6-1
IP connectivity group announcement response

| Information element | Status | Description |
|---|---|---|
| MC user ID | M | The MC ID of the requesting MC user |
| List of IOPS groups | M | it lists the IOPS MC service group IDs |
| | | for which the group announcement |
| | | request was accepted |

### 10.x.2.7 IP Connectivity Group Announcement Request (from the IOPS MC Connectivity Function to the IOPS Connectivity Client)

Table 10.x.2.7-1 describes the information flow for the IP connectivity group announcement request from the IOPS MC connectivity function to the IOPS connectivity client. This IP connectivity group announcement request is used to announce the availability of MC users from a specific IOPS MC service group ID within the system. The availability only indicates the number of available discovered users from the IOPS MC service group ID.

TABLE 10.x.2.7-1
IP connectivity group announcement request

| Information | | |
|---|---|---|
| element | Status | Description |
| MC user ID | M | The MC ID associated to the IOPS MC service |
| | | group ID receiving the announcement request |
| IOPS group | M | The announcing IOPS MC service group ID for |
| | | which group connectivity information is being |
| | | provided |
| Group | M | It indicates the number of other discovered MC |
| connectivity | | users on the IOPS MC system associated to the |
| information | | corresponding IOPS MC service group ID |

### 10.x.2.8 IP Connectivity Group Announcement Response (From the IOPS Connectivity Client to the IOPS MC Connectivity Function)

Table 10.x.2.8-1 describes the information flow for the IP connectivity group announcement response from the IOPS connectivity client to the IOPS MC connectivity function.

TABLE 10.x.2.8-1
IP connectivity group announcement response

| Information | | |
|---|---|---|
| element | Status | Description |
| MC user ID | M | The MC ID of the responding MC user |
| IOPS group | M | The IOPS MC service group ID for which group |
| | | connectivity information was received |

### 10.x.3 Procedures

The procedure for the IP connectivity announcement from MC users in the IOPS mode of operation is described in FIG. 10.x.3-1.

### Pre-Conditions:

The MC service users are discovered by the IOPS MC system.
1. The IOPS connectivity client 1 decides to announce its IP connectivity availability for one or more of its associated MC service IDs to other available MC users on the IOPS MC system. Therefore, it sends an IP connectivity announcement request to the IOPS MC connectivity function. The IOPS connectivity client may also indicate that its IP connectivity availability announcement is only targeting a specific list of MC service IDs that may be within the system.
2. The IOPS MC connectivity function checks if the announcement request for the related MC service ID(s) can be accepted. If it does, the IP connectivity announcement request is transmitted to the related MC users.
   NOTE 1: An announcement request can be accepted if the indicated MC service ID(s) from the requesting MC user has been provided in its IOPS discovery request.
   NOTE 2: An IP connectivity announcement request implicitly indicates that the requesting MC user's connectivity information can be made available to other MC users (or indicated targeted MC users) on the IOPS MC system.
3. The IOPS MC connectivity function provides to the IOPS connectivity client the announcement response for the related request.
4. The IOPS MC connectivity function transmits the IP connectivity announcement request to the related MC users.
5. The IOPS connectivity client provides to the IOPS MC connectivity function the announcement response for the related request.

The procedure for the IP connectivity group announcement from MC users in the IOPS mode of operation is described in FIG. 10.x.3-2.

### Pre-Conditions:

The MC service users are discovered by the IOPS MC system.
The MC service users have previously provided group IP connectivity information in the IOPS discovery request to the IOPS MC connectivity function.
It is assumed that the MC users related to the shown IOPS connectivity clients have been configured to belong to the same IOPS MC service group ID. This was then indicated within the group IP connectivity information in the IOPS discovery request to the IOPS MC connectivity function, respectively.
1. The IOPS connectivity client 1 decides to announce its IP connectivity availability for one or more of its associated IOPS MC service group IDs to other available MC user group members on the IOPS MC system. Therefore, it sends an IP connectivity group announcement request to the IOPS MC connectivity function.
2. The IOPS MC connectivity function checks if the group announcement request for the related IOPS MC service group ID can be accepted. If it does, the IP connectivity group announcement request is transmitted to other MC users related to the corresponding IOPS MC service group ID(s).
   NOTE 1: A group announcement request can be accepted if the indicated IOPS MC service group ID(s) from the requesting MC user has been provided in its IOPS discovery request.
   NOTE 2: An IP connectivity group announcement request implicitly indicates that the requesting MC user's connectivity information can be made available to other MC users (or indicated targeted MC users) on the IOPS MC system.
3. The IOPS MC connectivity function provides to the IOPS connectivity client the group announcement response for the related request.
4. The IOPS MC connectivity function transmits the IP connectivity group announcement request to other MC users related to the corresponding IOPS MC service group ID(s).
5. The IOPS connectivity client provides to the IOPS MC connectivity function the group announcement response for the related request.

### 3GPP TSG-SA WG6 Meeting #34 S6-192xxx

Reno, Nev., USA, 11^{th}-15^{th} Nov. 2019 (revision of S6-19xxxx)

### Source: Ericsson

Title: Pseudo-CR on IOPS discovery

### Spec: 3GPP TS 23.180 v0.1.0

Agenda item: 10.2

### Document for: Approval

Contact: Camilo Solano (camilo.solano@ericsson.com)

1. Introduction

The IP connectivity functionality includes an IOPS discovery procedure. The IOPS discovery procedure includes that an authenticated MC user requests to the IOPS MC system the support of IP connectivity and provides connectivity information for the support of MC services.

2. Reason for Change

Definition of the IOPS discovery procedure to be used for the MC services support based on IP connectivity in the IOPS mode of operation.

3. Conclusions

<Conclusion part (optional)>

4. Proposal

It is proposed to approve the following changes to 3GPP TS 23.180 v0.1.0.

### First Change

### 10.X IP Connectivity Functionality: IOPS Discovery

### 10.x.1 General

The support of the IP connectivity functionality in the IOPS mode of operation enables that MC services are provided by the MC service clients operating on the MC service UEs via the IOPS MC system. An IOPS MC system provides IP connectivity for the communication among MC service users based on an IOPS discovery procedure.

The IOPS discovery procedure enables that the IOPS MC system discovers MC service users and receives connectivity information to establish an IP connectivity communication between discovered users.

The following clauses specify the IOPS discovery procedure and information flows for the IP connectivity functionality in the IOPS mode of operation.

### 10.x.2 Information Flows10.x.2.1 IP Connectivity Request

Table 10.x.2.1-1 describes the information flow for the IP connectivity request from the IOPS connectivity client to the IOPS MC connectivity function.

TABLE 10.x.2.1-1
IP connectivity request

| Information element | Status | Description |
|---|---|---|
| MC user ID (NOTE) | M | The MC ID of the user requesting support |
| | | of the IP connectivity functionality |

NOTE:
The MC user ID can be a user identity to be used only in the IOPS mode of operation.

### 10.x.2.2 IP Connectivity Response

Table 10.x.2.2-1 describes the information flow for the IP connectivity response from the IOPS MC connectivity function to the IOPS connectivity client.

TABLE 10.x.2.2-1
IP connectivity response

| Information | | |
|---|---|---|
| element | Status | Description |
| MC user ID | M | The MC ID of the user requesting support |
| | | of the IP connectivity functionality |
| IP connectivity | M | It indicates if the IP connectivity functionality |
| support | | is supported or not for the user |

### 10.x.2.3 IOPS Discovery Request

Table 10.x.2.3-1 describes the information flow for the IOPS discovery request from the IOPS connectivity client to the IOPS MC connectivity function.

TABLE 10.x.2.3-1
IOPS discovery request

| Information element | Status | Description |
|---|---|---|
| MC user ID (NOTE 1) | M | The MC ID of the user requesting to be discovered |
| List of MC service IDs | M | List of MC service IDs (e.g. MCPTT ID, MCData ID) |
| (NOTE 2) | | of the requesting MC user |
| IP connectivity information | M | It includes the requesting MC service UE’s IP |
| | | address assigned by the IOPS EPS for the IP |
| | | connectivity functionality |
| Group IP connectivity | O | It includes the list of IOPS groups (IOPS MC |
| information | | service group ID and its associated IOPS group IP |
| | | multicast address) the requesting MC user is |
| | | configured with (NOTE 3) |
| Availability of connectivity | O | It indicates if the connectivity information of the |
| information | | requesting MC user can be made available to other |
| | | users on the system |
| List of MC service IDs | O | The specific list of MC service IDs (e.g. MCPTT ID, |
| | | MCData ID) that the requesting MC user’s |
| | | connectivity information can be shared with |

NOTE 1:
The MC user ID can be a user identity to be used only in the IOPS mode of operation.
NOTE 2:
The MC service IDs can be service user identities to be used only in the IOPS mode of operation.
NOTE 3:
The list of IOPS groups (IOPS MC group ID and its associated IP multicast address) refers to the list of MC service groups for use by an MC service user in the IOPS mode of operation.

### 10.x.2.4 IOPS Discovery Response

Table 10.x.2.4-1 describes the information flow for the IOPS discovery response from the IOPS MC connectivity function to the IOPS connectivity client.

TABLE 10.x.2.4-1
IOPS discovery response

| Information element | Status | Description |
|---|---|---|
| MC user ID | M | The MC ID of the user requesting |
| | | to be discovered |
| Connectivity status | M | It indicates the connectivity status |
| | | of the requesting MC user on the |
| | | system |

### 10.x.3 Procedure

The procedure for the discovery of MC users in the IOPS mode of operation is described in FIG. 10.x.3-1. The IOPS discovery is initiated by the MC users to make use of the IP connectivity functionality.

### Pre-Conditions:

The MC service user is authenticated on the IOPS MC system.
1. The IOPS connectivity client requests to the IOPS MC connectivity function the support of the IP connectivity functionality for the support of MC services.
2. The IOPS MC connectivity function indicates to the MC user the support of the IP connectivity functionality for the support of MC services.
3. The MC user sends an IOPS discovery request to the IOPS MC connectivity function. The request includes providing connectivity information for the support of MC services based on the IP connectivity functionality.
4. The IOPS MC connectivity function stores the information received from the MC user and registers the user's connectivity status as discovered.
5. The IOPS MC connectivity function provides a response to the IOPS connectivity client indicating the success or failure of the discovery of the requesting MC user.

### 3GPP TSG-SA WG6 Meeting #34 S6-192xxx

Reno, Nev., USA, 11^{th}-15^{th} Nov. 2019 (revision of S6-19xxxx)

### Source: Ericsson

Title: Pseudo-CR on IOPS subscription and notification

### Spec: 3GPP TS 23.180 v0.1.0

Agenda item: 10.2

### Document for: Approval

Contact: Camilo Solano (camilo.solano@ericsson.com)

1. Introduction

The IP connectivity functionality in the IOPS mode of operation includes procedures for user subscription and notification. Thus, a user can subscribe to be notified about the availability of other user(s) within the IOPS MC system to communicate with based on the IP connectivity functionality.

2. Reason for Change

Definition of the IOPS subscription and notification procedures to be used for the MC services support based on IP connectivity in the IOPS mode of operation.

3. Conclusions

<Conclusion part (optional)>

4. Proposal

It is proposed to approve the following changes to 3GPP TS 23.180 v0.1.0.

### First Change

### 10.X IP Connectivity Functionality: IOPS Subscription and Notification

### 10.x.1 General

The support of the IP connectivity functionality in the IOPS mode of operation enables that MC services are provided by the MC service clients operating on the MC service UEs via the IOPS MC system. An MC user that has been discovered by the IOPS MC system can subscribe to be notified about the connectivity information of other discovered MC users on the IOPS MC system. Also, a discovered MC user can subscribe to be notified about the number of other discovered MC users on the IOPS MC system from its associated IOPS groups.

The following clauses specify the IOPS subscription and notification procedures and information flows for the IP connectivity functionality in the IOPS mode of operation.

### 10.x.2 Information flows10.x.2.1 IP Connectivity Subscribe Request

Table 10.x.2.1-1 describes the information flow for the IP connectivity subscribe request from the IOPS connectivity client to the IOPS MC connectivity function.

TABLE 10.x.2.1-1
IP connectivity subscribe request

| Information element | Status | Description |
|---|---|---|
| MC user ID | M | The MC ID of the requesting MC user |
| List of MC service IDs | O | List of MC service IDs (e.g. MCPTT ID, |
| (NOTE 1) | | MCData ID) the requesting MC user |
| | | subscribes to receive connectivity |
| | | information from |
| List of IOPS groups | O | List of IOPS groups (IOPS MC service |
| (NOTE 1 and NOTE 2) | | group IDs) the requesting MC user |
| | | subscribes to receive group |
| | | connectivity information from |

NOTE 1:
At least one should be present.
NOTE 2:
The IOPS group(s) should belong to the list of IOPS groups the requesting MC user included as part of the group IP connectivity information in the IOPS discovery request.

### 10.x.2.2 IP Connectivity Subscribe Response

Table 10.x.2.2-1 describes the information flow for the IP connectivity subscribe response from the IOPS MC connectivity function to the IOPS connectivity client.

TABLE 10.x.2.2-1
IP connectivity subscribe response

| Information element | Status | Description |
|---|---|---|
| MC user ID | M | The MC ID of the requesting MC user |
| Subscription status | M | It lists the subscription status, success |
| | | or failure, of the requested subscription(s) |

### 10.x.2.3 IP Connectivity Notify Request

Table 10.x.2.3-1 describes the information flow for the IP connectivity notify request from the IOPS MC connectivity function to the IOPS connectivity client.

TABLE 10.x.2.3-1
IP connectivity notify request

| Information | | |
|---|---|---|
| element | Status | Description |
| MC user ID | M | The MC ID of the MC user with active |
| | | subscription(s) |
| MC service ID | M | The MC service ID associated to the active |
| (NOTE) | | subscription for which connectivity information is |
| | | being notified |
| Connectivity | M | It provides connectivity information about the MC |
| information | | service ID of the corresponding subscription. It |
| (NOTE) | | includes the MC service UE’s IP address of the |
| | | associated MC service ID in the system |

NOTE:
It can be a list associated to multiple active subscriptions.

### 10.x.2.4 IP Connectivity Notify Response

Table 10.x.2.4-1 describes the information flow for the IP connectivity notify response from the IOPS connectivity client to the IOPS MC connectivity function.

TABLE 10.x.2.4-1
IP connectivity notify response

| Information | | |
|---|---|---|
| element | Status | Description |
| MC user ID | M | The MC ID of the responding MC user |
| MC service ID | M | The MC service ID for which |
| (NOTE) | | connectivity information was received |

NOTE:
It can be a list associated to multiple active subscriptions.

### 10.x.2.5 IP Connectivity Group Notify Request

Table 10.x.2.5-1 describes the information flow for the IP connectivity group notify request from the IOPS MC connectivity function to the IOPS connectivity client.

TABLE 10.x.2.5-1
IP connectivity group notify request

| Information | | |
|---|---|---|
| element | Status | Description |
| MC user ID | M | The MC ID of the MC user with active |
| | | subscription(s) |
| IOPS group | M | The IOPS MC service group ID related to the |
| (NOTE) | | active group subscription for which group |
| | | connectivity information is being notified |
| Group connectivity | M | It indicates the number of other discovered |
| information | | MC users on the IOPS MC system of the |
| (NOTE) | | corresponding group subscription |

NOTE:
It can be a list associated to multiple active group subscriptions.

10.x.2.6 IP Connectivity Group Notify Response

Table 10.x.2.6-1 describes the information flow for the IP connectivity group notify response from the IOPS connectivity client to the IOPS MC connectivity function.

TABLE 10.x.2.6-1
IP connectivity group notify response

| Information | | |
|---|---|---|
| element | Status | Description |
| MC user ID | M | The MC ID of the responding MC user |
| IOPS group | M | The IOPS MC service group ID for which |
| (NOTE) | | group connectivity information was received |

NOTE:
It can be a list associated to multiple active group subscriptions.

### 10.x.3 Procedures

The procedure for the IP connectivity subscription of MC users in the IOPS mode of operation is described in FIG. 10.x.3-1.

### Pre-Conditions:

The MC service user is discovered by the IOPS MC system.
The MC service user has decided to subscribe to receive connectivity information of other discovered MC users and/or IOPS groups on the IOPS MC system.
For subscriptions associated to IOPS groups, the MC service user has previously provided group IP connectivity information in the IOPS discovery request to the IOPS MC connectivity function.
1. The IOPS connectivity client subscribes to receive connectivity information of other discovered MC users and/or groups on the IOPS MC system.
2. The IOPS MC connectivity function checks if a subscription for the MC service ID(s) and/or IOPS group(s) included in the request can be activated for the requesting MC user.
   NOTE: A subscription cannot be activated if an MC user associated to the requested MC service ID has indicated in its IOPS discovery request that its connectivity information is not available to other users on the IOPS MC system. Besides, a subscription cannot be activated if a requested IOPS group doesn't belong to the list of IOPS groups the requesting MC user has included as part of the group IP connectivity information in the IOPS discovery request.
3. The IOPS MC connectivity function indicates to the IOPS connectivity client the subscription status associated to the request.

The procedure for the IP connectivity notification of MC users in the IOPS mode of operation is described in FIG. 10.x.3-2.

### Pre-Conditions:

The MC service user has an active IP connectivity subscription associated to one or multiple MC service IDs.
The IOPS MC connectivity function has available information related to an IP connectivity subscription associated to one or multiple MC service IDs.
1. The IOPS MC connectivity function notifies to the IOPS connectivity client the connectivity information related to an active IP connectivity subscription associated to one or multiple MC service IDs. The connectivity information may be retrieved by the MC service client to establish an MC service communication based on the IP connectivity functionality.
2. The IOPS connectivity client provides an IP connectivity notify response to the IOPS MC connectivity function.

The procedure for the IP connectivity group notification of MC users in the IOPS mode of operation is described in FIG. 10.x.3-3.

### Pre-Conditions:

The MC service user has an active IP connectivity subscription associated to one or multiple IOPS MC service group IDs.
The IOPS MC connectivity function has available information related to an IP connectivity subscription associated to one or multiple IOPS MC service group IDs.
1. The IOPS MC connectivity function notifies to the IOPS connectivity client the group connectivity information related to an active IP connectivity group subscription associated to one or multiple IOPS MC service group IDs. The group connectivity information may be retrieved by the MC service client to establish an MC service group communication based on the IP connectivity functionality.
2. The IOPS connectivity client provides an IP connectivity group notify response to the IOPS MC connectivity function.

1-59. (canceled)

60. A method performed by a wireless communication device, the method comprising:
sending, to an isolated operation for public safety, IOPS, mission critical, MC, system associated with one or more radio access nodes of a cellular communications system, an Internet Protocol, IP, connectivity announcement request or an IP connectivity group announcement request for announcing availability of the wireless device to one or more other devices served by the IOPS MC system; and
receiving, from the IOPS MC system, an IP connectivity announcement response or an IP connectivity group announcement response.

61. The method of claim 60 wherein sending comprises sending the IP connectivity announcement request, the IP connectivity announcement request comprising:
an identifier of the wireless communication device; and
one or more MC service identifiers associated with the wireless communication device to be announced as being available to other MC service enabled wireless communication devices.

62. The method of claim 60 wherein sending comprises sending the IP connectivity announcement request, the IP connectivity announcement request comprising:
an identifier of the wireless communication device; and
one or more MC service user identifiers associated with the wireless communication device to be announced as being available to other MC service enabled wireless communication devices.

63. The method of claim 61 wherein the IP connectivity announcement request further comprises one or more target MC service identifiers to which IP connectivity information for the wireless communication device is to be announced.

64. The method of claim 62 wherein the IP connectivity announcement request further comprises one or more target MC service user identifiers to which IP connectivity information for the wireless communication device is to be announced.

65. The method of claim 61 wherein the other MC service enabled wireless communication devices are at least some other MC service enabled wireless communication devices that are discovered by the IOPS MC system.

66. The method of claim 61 wherein receiving comprises receiving the IP connectivity announcement response, the IP connectivity announcement response comprising:
an identifier of the wireless communication device; and
one or more MC service identifiers associated with the wireless communication device or one or more MC service user identifiers associated with the wireless communication device, for which the IP connectivity announcement request is accepted by the IOPS MC system.

67. The method of claim 66 wherein the IP connectivity announcement response further comprises one or more target MC service identifiers or one or more target MC service user identifiers, for which the IP connectivity announcement request is accepted by the IOPS MC system.

68. The method of claim 60 wherein sending comprises sending the IP connectivity group announcement request, the IP connectivity group announcement request comprising:
an identifier of the wireless communication device; and
information that identifies one or more MC service groups for which the wireless communication device intends to announce its availability on the IOPS MC system.

69. The method of claim 68 wherein receiving comprises receiving the IP connectivity group announcement response, the IP connectivity group announcement response comprising:
an identifier of the wireless communication device; and
information that identifies one or more MC service groups for which the IP connectivity group announcement request is accepted by the IOPS MC system.

70. A wireless communication device adapted to:
send, to an isolated operation for public safety, IOPS, mission critical, MC, system associated with one or more radio access nodes of a cellular communications system, an Internet Protocol, IP, connectivity announcement request or an IP connectivity group announcement request for announcing availability of the wireless device to one or more other devices served by the IOPS MC system; and
receive, from the IOPS MC system, an IP connectivity announcement response or an IP connectivity group announcement response.

71. A wireless communication device comprising:
one or more transmitters;
one or more receivers; and
processing circuitry associated with the one or more transmitters and the one or more receivers, the processing circuitry configured to cause the wireless communication device to:
send, to an isolated operation for public safety, IOPS, mission critical, MC, system associated with one or more radio access nodes of a cellular communications system, an Internet Protocol, IP, connectivity announcement request or an IP connectivity group announcement request for announcing availability of the wireless device to one or more other devices served by the IOPS MC system; and
receive, from the IOPS MC system, an IP connectivity announcement response or an IP connectivity group announcement response.

72. The wireless communication device of claim 71 wherein the processing circuitry is configured to cause the wireless communication device to send the IP connectivity announcement request, the IP connectivity announcement request comprising:
an identifier of the wireless communication device; and
one or more MC service identifiers associated with the wireless communication device to be announced as being available to other MC service enabled wireless communication devices.

73. The wireless communication device of claim 71 wherein the processing circuitry is configured to cause the wireless communication device to send the IP connectivity announcement request, the IP connectivity announcement request comprising:
an identifier of the wireless communication device; and
one or more MC service user identifiers associated with the wireless communication device to be announced as being available to other MC service enabled wireless communication devices.

74. The wireless communication device of claim 72 wherein the IP connectivity announcement request further comprises one or more target MC service identifiers to which IP connectivity information for the wireless communication device is to be announced.

75. The wireless communication device of claim 73 wherein the IP connectivity announcement request further comprises one or more target MC service user identifiers to which IP connectivity information for the wireless communication device is to be announced.

76. The wireless communication device of claim 72 wherein the other MC service enabled wireless communication devices are at least some other MC service enabled wireless communication devices that are discovered by the IOPS MC system.

77. The wireless communication device of claim 72 wherein the processing circuitry is configured to cause the wireless communication device to receive the IP connectivity announcement response, the IP connectivity announcement response comprising:
an identifier of the wireless communication device; and
one or more MC service identifiers associated with the wireless communication device or one or more MC service user identifiers associated with the wireless communication device, for which the IP connectivity announcement request is accepted by the IOPS MC system.

78. The wireless communication device of claim 77 wherein the IP connectivity announcement response further comprises one or more target MC service identifiers or one or more target MC service user identifiers, for which the IP connectivity announcement request is accepted by the IOPS MC system.

79. The wireless communication device of claim 71 wherein:
the processing circuitry is configured to cause the wireless communication device to send the IP connectivity group announcement request, the IP connectivity group announcement request comprising:
an identifier of the wireless communication device; and
information that identifies one or more MC service groups for which the wireless communication device intends to announce its availability on the IOPS MC system; and
the processing circuitry is configured to cause the wireless communication device to receive the IP connectivity group announcement response, the IP connectivity group announcement response comprising:
an identifier of the wireless communication device; and
information that identifies one or more MC service groups for which the IP connectivity group announcement request is accepted by the IOPS MC system.
